(19) United States
(12) Patent Application Publication
(10) Pub. No.: US 2026/0270927 A1
(43) Pub. Date: Sep. 10, 2026

(54) RANGING WITH DYNAMIC PACKET BANDWIDTH SELECTION

(71) Applicant: QUALCOMM Incorporated, San Diego, CA (US)

(72) Inventors: Mahmoud Munsaf M BADI, San Jose, CA (US); Feliciano GOMEZ MARTINEZ, Los Gatos, CA (US); Xiaoxin ZHANG, Sunnyvale, CA (US)

(21) Appl. No.: 19/071,259

(22) Filed: Mar. 5, 2025

(51) Int. Cl. H04W 64/00; G01S 11/06; H04W 28/20

(52) U.S. Cl. CPC H04W 64/00; G01S 11/06; H04W 28/20

(57) ABSTRACT

Aspects presented herein may enable a first user equipment (UE) to perform ranging with a second UE based on a dynamic packet bandwidth selection to improve ranging capabilities for UEs at far distances or in scenarios with higher path loss/interference. In one aspect, a first UE identifies a packet bandwidth in which the first UE is able to detect a second UE and perform ranging with the second UE. The first UE performs the ranging with the second UE based on the packet bandwidth. The first UE adjusts the packet bandwidth for the ranging based on at least one of: (1) comparing a received signal strength indicator (RSSI) of the packet bandwidth with at least one threshold, (2) a maximum ranging distance supported by the packet bandwidth, or (3) a time of arrival indicator and a relative RSSI change.

### TECHNICAL FIELD

The present disclosure relates generally to communication systems, and more particularly, to wireless communication involving tracking and ranging.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Some telecommunication standards also provide positioning (e.g., including tracking and/or ranging) protocols and techniques that enable mobile network operators to provide high-accuracy location/tracking/ranging services to their subscribers. For example, 5G NR include various standards for network-based positioning that use signals and features of the 5G network to perform or improve the positioning of a device. There also exists a need for further improvements in these positioning protocols and techniques.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus identifies a bandwidth in which the first UE is able to detect a second UE and perform ranging with the second UE. The apparatus performs the ranging with the second UE based on the bandwidth. The apparatus adjusts the bandwidth for the ranging based on at least one of: (1) comparing a received signal strength indicator (RSSI) of the bandwidth with at least one threshold, (2) a maximum ranging distance supported by the bandwidth, or (3) a time of arrival indicator and a relative RSSI change.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements in accordance with various aspects of the present disclosure.

FIG. 5 is a diagram illustrating an example of tracking in accordance with various aspects of the present disclosure.

FIG. 6 is a diagram illustrating an example of a tracking device moving through space while measuring time of flight (ToF) distance to a target device in accordance with various aspects of the present disclosure.

FIG. 7 is a diagram illustrating an example procedure for round-trip time (RTT)/ToF estimation between two wireless devices in accordance with various aspects of the present disclosure.

FIG. 8 is a diagram illustrating an example scenario of an RTT error impacting on directional accuracy of ranging in accordance with various aspects of the present disclosure.

FIG. 9 is a diagram illustrating an example of simulation results in accordance with various aspects of the present disclosure.

FIG. 10 is a table illustrating an example of an RTT ranging performance indicator in different bandwidths in accordance with various aspects of the present disclosure.

FIG. 11 is a diagram illustrating an example of performing ranging with dynamic ranging bandwidth in accordance with various aspects of the present disclosure.

FIG. 12 is a diagram illustrating an example of a ranging lost due to weak received signal strength in accordance with various aspects of the present disclosure.

FIG. 13A is a diagram illustrating example roles for an ultra-wideband (UWB) ranging operation in accordance with various aspects of the present disclosure.

FIG. 13B is a diagram illustrating example roles for an UWB ranging operation in accordance with various aspects of the present disclosure.

FIG. 14 is a diagram illustrating an example of an iterative packet bandwidth (BW) selection to enable ranging in far distances and/or high pathloss scenarios in accordance with various aspects of the present disclosure.

FIG. 15 is a diagram illustrating an example of a maximum distance-informed packet BW selection for ranging in accordance with various aspects of the present disclosure.

FIG. 16 is a diagram illustrating an example of selecting the packet BW for ranging based on an intersection and/or an area of overlap between two distributions in accordance with various aspects of the present disclosure.

FIG. 17 is a diagram illustrating an example user experience of a ranging device locating a target device in accordance with various aspects of the present disclosure.

FIG. 18 is a flowchart of a method of wireless communication.

FIG. 19 is a diagram illustrating an example of a hardware implementation for an example apparatus and/or network entity.

### DETAILED DESCRIPTION

Various aspects relate generally to wireless communication and more particularly to tracking and/or ranging based on wireless communication. Some aspects more specifically relate to improving the overall performance and accuracy of ranging by enabling a ranging device (which may be referred to as a first user equipment (UE) or a first wireless device in some examples) to perform ranging with a target (which may be referred to as a second UE or a second wireless device in some examples) with dynamic packet bandwidth (BW). In one aspect, at far ranges or in scenarios where received signal strength indicator (RSSI) is very low/poor, the ranging device and the target may negotiate or re-negotiate the choice of packet BW (which may also be referred to as the “packet BW”) to achieve ranging which may not be possible otherwise. For example, the ranging device and the target may agree to drop the BW mode totally to 20 MHz, in a one-mode step (e.g., 160 to 20 MHz), or in a more intelligent manner. Lowering the BW may enable the ranging device to reach further ranges. Even if the ranging accuracy drops, it may be tolerated in some occasions as ranging error at true large distances may have little effect/impact compared to short distances. For example, a 5 meter error may be tolerated when the true distance is 110 meters but may not be as tolerated if the true distance is 10 meters. When ranging is happening at a low BW mode and the user is moving roughly toward the target device, accuracy becomes the goal and the ranging device may be configured to switch to BW modes that may result in higher accuracy if/when possible. Aspects presented herein may enable a ranging device to sacrifice accuracy for the benefit of maintaining ranging capabilities. Then, when ranging is maintained, albeit at low accuracy, the ranging device and the target may move closer and/or in the right direction until RSSI becomes better and higher ranging accuracy can be achieved through switching back to the higher BW mode.

Aspects presented herein provide various mechanisms for dynamic packet BW selection to improve ranging capabilities for ranging devices at far distances or in scenarios with higher path loss/interference. In one aspect, a ranging device (and a target) may be configured to iteratively drop the packet BW until detection is achieved and ranging is possible. This configuration may help in enabling ranging in scenarios where it is either lost or not possible. Then, after connection and ranging is achieved at the (most probably) lower BW by the ranging device and the target, the ranging device (and the target) may be configured to apply an RSSI-based packet BW selection for the ranging. This configuration may improve the ranging accuracy/performance. In another aspect of the present disclosure, the ranging device (and the target) may be configured to rely on prior information about the maximum possible supported distance and the distance error distribution to guide packet BW selection. In another aspect of the present disclosure, the ranging device (and the target) may also be configured to use time-of-arrival (ToA) indicator and relative change(s) in RSSI to decide on when to change the packet BW.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

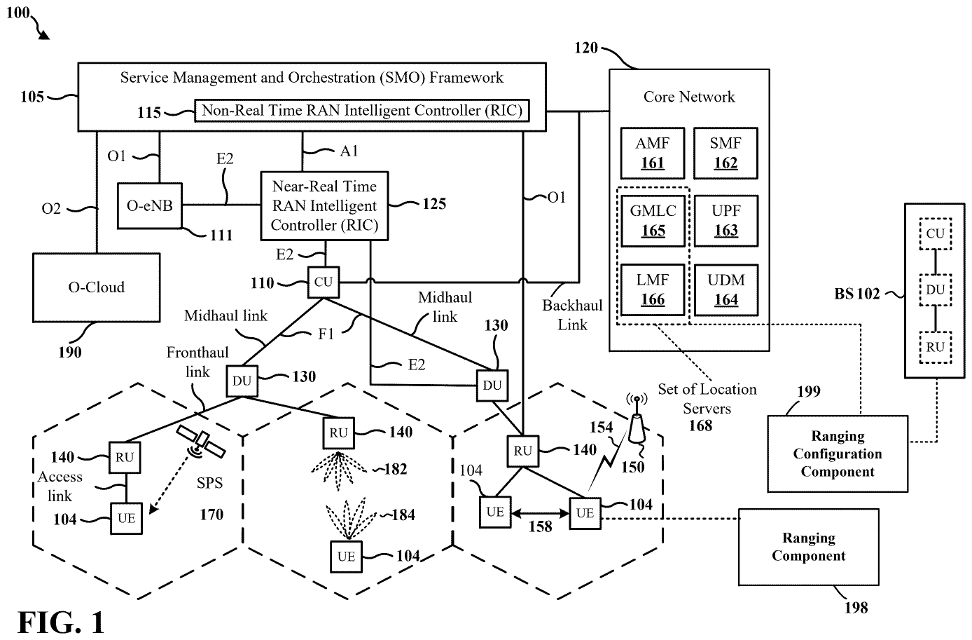

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a ranging component 198 that may be configured to identify a bandwidth in which the first UE is able to detect a second UE and perform ranging with the second UE; perform the ranging with the second UE based on the bandwidth; and adjust the bandwidth for the ranging based on at least one of: (1) comparing a received signal strength indicator (RSSI) of the bandwidth with at least one threshold, (2) a maximum ranging distance supported by the bandwidth, or (3) a time of arrival indicator and a relative RSSI change. In certain aspects, the base station 102 and/or the one or more location servers 168 may have a ranging configuration component 199 that may be configured to provide configurations and/or parameters related to tracking/ranging for the UE 104.

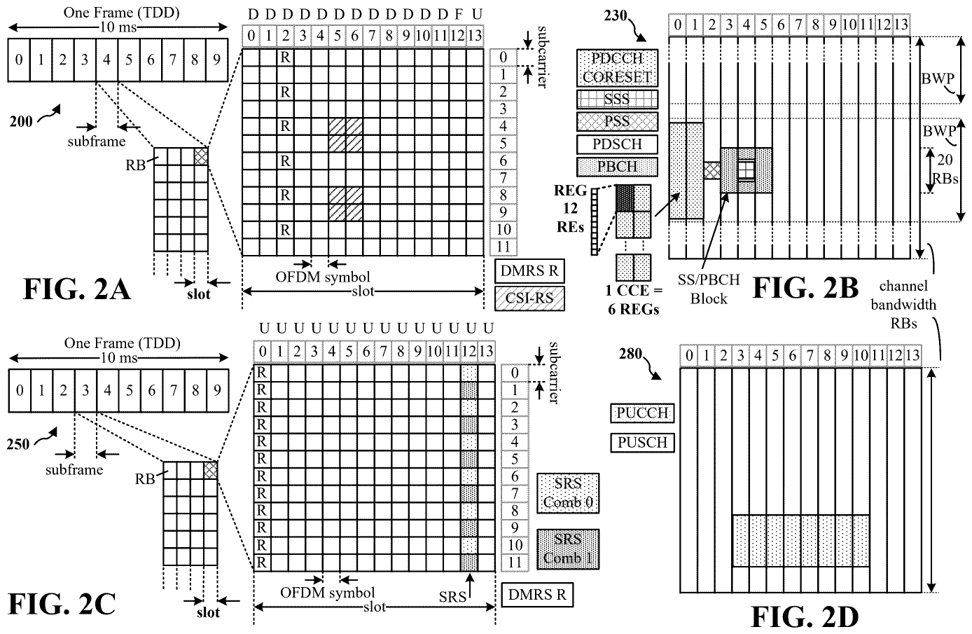

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δƒ = 2^{μ} · 15[KHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

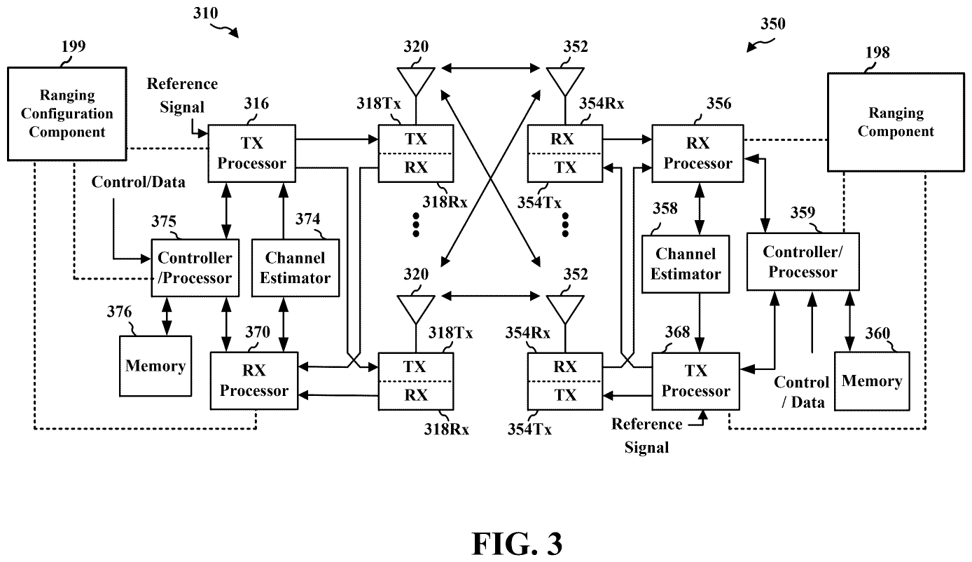

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the ranging component 198 of FIG. 1.

At least one of the TX processor 316, the RX processor 370, and the controller/processor 375 may be configured to perform aspects in connection with the ranging configuration component 199 of FIG. 1.

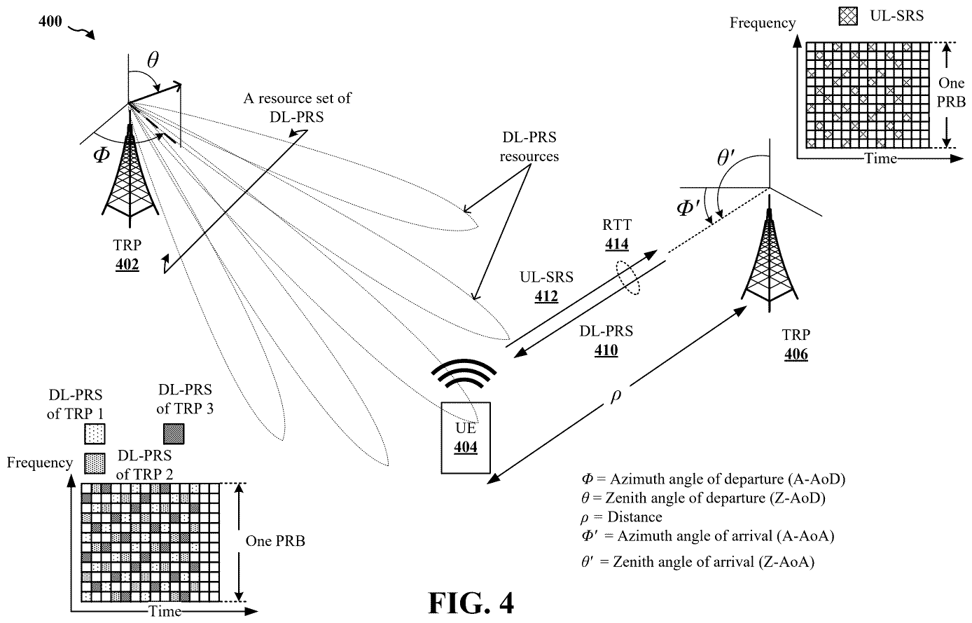

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on |T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx−Tx time difference measurements (and/or DL PRS-RSRP of the received signals) using assistance data received from the positioning server, and the TRPs 402, 406 measure the gNB Rx−Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle-of-arrival (A-AoA) and zenith angle-of-arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

In addition to the network-based positioning described in connection with FIG. 4, various positioning methods/mechanisms have also been developed for localizing or tracking the position of a target. These positioning methods/mechanisms may be classified into active positioning (which may also be referred to and used interchangeably with “active localization”) and passive positioning (which may also be referred to and used interchangeably with “passive localization”). For active positioning, a wireless device may locate a target based on signals transmitted from the target. For example, the target may be attached or configured with a radio frequency (RF)-capable device/component, such as a tag (e.g., an RF tag), a Global Positioning System (GPS)/wireless tracker, a device/component capable of transmitting/receiving positioning reference signals, a device/component capable of performing or responding to ranging/radar operations, etc. Then, based on signals transmitted from the target (or from the RF-capable device/component attached to the target), the wireless device may calculate or estimate the location of the target (e.g., the relative location, distance, and/or direction of the target from the wireless device). On the other hand, for passive positioning, a target may be localized and tracked without attaching an RF-capable device/component to the target. For example, RF radars, light detection and rangings (Lidars), sonars, and/or cameras are example technologies/components that may be used by a wireless device for passive positioning, where the wireless device may locate a target based on images or based on reflection of signals, etc.

A wireless device may be able to locate and track a target or another wireless device based on using one or more tracking/ranging technologies. For purposes of the present disclosure, tracking technologies may refer to methods and systems that are used for estimating, monitoring, and/or following the movements/locations of a target (e.g., an object, a person, an animal, a vehicle, etc.) over time. Tracking technologies may have different applications across various industries, and may use different principles and devices to achieve the tracking. Depending on implementations, some tracking technologies may be based on ranging operations, which may be referred to as ranging technologies. A ranging operation/technology may refer to a method/technique that is used to measure the distance between two points or objects. An example of ranging operation/technology may include a user locating a target device (e.g., a Bluetooth® device such as a pair of earbuds) using a mobile device (e.g., a smartphone), where the mobile device may continue to estimate the distance and/or location of the target device based on signals from the target device. Depending on the context, in some examples, the term “track/tracking” may be used interchangeably with the term “position/positioning” or “location/locationing.” For example, a wireless device may be configured to track a target based on estimating the position/location of the target using Wi-Fi technologies, which may be referred to as Wi-Fi tracking or Wi-Fi positioning/locationing. Similarly, depending on the context, in some examples, the term “tracking” may be used interchangeably with the term “ranging.” For example, a wireless device may be configured to track a target based on performing ranging with the target using ultra-wideband (UWB) technologies, which may be referred to as UWB/UWB-based tracking or ranging.

The tracking technologies may be used in various fields such as surveying, navigation, robotics, telecommunications, etc. Examples of tracking technologies may include:
(1) global navigation satellite system (GNSS)/global positioning system (GPS) tracking-GNSS/GPS tracking relies on a network of satellites to provide real-time location information. GNSS/GPS receivers, often embedded in devices like smartphones, vehicles, or wearables, may determine their precise location and movement.
(2) radio-frequency identification (RFID) tracking-RFID technology uses radio waves to identify and track objects equipped with RFID tags, where these RFID tags may include electronic information that can be read by RFID readers, enabling the tracking of items in logistics, inventory management, and access control.
(3) Bluetooth® (BT) tracking-Bluetooth technology may be used for tracking by measuring the signal strength between devices. Bluetooth channel sounding (CS) (BTCS) is another technique that may also be used for tracking by measuring the round-trip-time (RTT)/the phase delay of RF signals between devices. Bluetooth beacons or tags may be attached to objects or carried by individuals, and their proximity to Bluetooth receivers may be used to estimate their location.
(4) Wi-Fi® tracking-Wi-Fi tracking may involve using signals from Wi-Fi access points (APs) to estimate the location of target devices. This tracking method is often suitable for indoor environments, such as malls and airports, for tracking people or assets.
(5) cellular tracking-mobile network infrastructure may be able to track devices through the triangulation of cell tower signals. The approximate location of a mobile device can be determined by analyzing the signals it receives from nearby cell towers.
(6) inertial navigation systems—these systems may use accelerometers and gyroscopes to track changes in velocity and orientation.
(7) computer vision tracking-advanced computer vision technologies, including object recognition and tracking algorithms, may enable cameras and sensors to track the movement of objects or people based on visual data.
(8) ultra-wideband (UWB) tracking-UWB tracking may utilize signals with very high frequency ranges or bandwidths. UWB technology transmits data using a broad spectrum of frequencies, enabling precise and accurate tracking of objects or individuals in both indoor and outdoor environments. UWB tracking systems typically operate in the frequency range of 3.1 to 10.6 gigahertz.

As discussed above, ranging operations or technologies may refer to methods or techniques that is used to measure the distance between two points or objects. Examples of ranging operations/technologies may include:
(1) triangulation-triangulation involves measuring the angles between an observer and two known points or landmarks. By using trigonometry, the distance to the object may be calculated or estimated.
(2) time of flight (ToF)-ToF technology measures the time taken for a signal (such as light or sound) to travel from a transmitter to a target and back to a receiver. By knowing the speed of the signal, usually the speed of light or sound, the distance may be calculated or estimated.
(3) GNSS-GNSS systems, such as GPS, global navigation satellite system (GLONASS), Galileo, and BeiDou, use signals from satellites to determine the position of a receiver on Earth. By analyzing the amount of time it takes for signals from multiple satellites to reach the receiver, its position (including distance) may be calculated or estimated.
(4) RFID-RFID technology uses electromagnetic fields to automatically identify and track tags attached to objects. The distance between the reader and the RFID tag may be estimated based on the strength of the received signal.
(5) ultrasonic ranging-ultrasonic ranging involves emitting ultrasonic pulses and measuring the time it takes for the pulses to bounce back from the object. The speed of sound in the medium determines the distance.
(6) laser ranging (e.g., light detection and ranging (Lidar))—laser ranging uses lasers to measure the distance to a target by calculating the time it takes for laser pulses to travel to the target and back.

Among the aforementioned tracking/ranging technologies, in recent years, UWB, Bluetooth, and/or Wi-Fi based tracking/ranging have appeared to be widely used and developed for most wireless devices (e.g., consumer devices such as mobile phones, smart watches, etc.) due to their accessibility and tracking/ranging precisions.

UWB tracking/ranging may refer to using a UWB device/technology to locate and track objects, people, or assets within a certain range. A UWB device (e.g., a device that is capable of performing UWB tracking/ranging) may use pulse-based radio signaling (e.g., Short-pulse-UWB) instead of orthogonal frequency division multiplexing (OFDM)-based signaling (e.g., Multi-Band (MB)-OFDM-UWB (MB-OFDM-UWB)). Short-pulse-UWB signaling may transmit with the energy for each bit spread over the entire UWB channel bandwidth (e.g., 1.37 GHz, 4 GHZ, etc.) with varying pulse amplitude and/or pulse polarity without using a RF carrier while MB-OFDM-UWB may transmit each bit using a 4 MHz bandwidth channel.

Using short-pulse-UWB signaling systems may provide several advantages over MB-OFDM-UWB signaling systems and other OFDM-based systems. For example, a short-pulse-UWB signaling system may provide better fading characteristics (e.g., Gaussian-modeled fading versus Rayleigh-modeled fading, and/or less than 1% of channels experiencing 2 dB or more fading) than an MB-OFDM-UWB signaling system. As other examples, a short-pulse-UWB signaling system may operate accurately without employing FEC (Forward Error Correction), using no-rake processing, with lower peak-to-average RF, and/or with longer battery life than an MB-OFDM-UWB signaling system. Short-pulse-UWB also does not use traditional modulation and demodulation techniques such as Fast Fourier Transforms (FFT), but may use time-domain or space-time processing techniques. Short-pulse-UWB may utilize various shapes (e.g., Gaussian pulses, Monocycle pulses, Hermite pulses, etc.) and the shape used may be chosen based on their properties in time and frequency domains among other factors, such as Bandwidth utilization, Interference Mitigation, Power Spectral Density, Multipath fading and inter-symbol interference, design complexity, power consumption, range, tradeoffs for ultra-fast sampling, etc. Short-pulse-UWB, in some cases, may benefit from a high-speed Analog-to-Digital converter (ADC) and a high-speed Digital-to-Analog Converter (DAC) to be able to handle the very wide frequency band used; however, there may be other ways to handle the need for ultra-fast sampling such as using Time Hopping techniques, Direct Sequence coding techniques, etc.

MB-OFDM-UWB may divide up spectrum into several frequency sub-bands and OFDM is applied within each band; whereas, other OFDM systems may typically operate within a fixed frequency band. The complex waveform created by combining the multiple-sub-bands results in a final waveform that used for transmission for MB-OFDM-UWB. MB-OFDM-UWB also varies from other OFDM systems by not using a guard interval, using simpler modulation schemes like Binary Phase Shift keying (BPSK) or Quadrature phase-shift keying (QPSK) vs. 64 or 256 Quadrature Modulation (QAM), utilizes a constant power level whereas other OFDM systems may utilize power control for varying channel conditions, etc.

Bluetooth tracking/ranging may refer to using Bluetooth device/technology to locate and track objects, people, or assets within a certain range. This technology may rely on Bluetooth-enabled devices, such as smartphones, tablets, or specialized Bluetooth tags, to communicate with each other and determine their relative positions.

Bluetooth tracking may include beacon-based tracking and Bluetooth low energy (LE) tracking. Beacon-based tracking may involve deploying Bluetooth beacons that emit Bluetooth signals at regular intervals. These signals are picked up by Bluetooth-enabled devices in the vicinity, such as smartphones or tablets. By measuring the signal strength and timing of these beacon signals, the receiving devices can estimate their proximity to the beacon. This information may then be used to determine the location of the Bluetooth-enabled device within the range of the beacon. Bluetooth LE tracking may enable devices to communicate over short distances while consuming minimal power. Bluetooth LE tracking systems may include attaching tags to objects or carried by individuals, and Bluetooth LE receivers (such as smartphones or dedicated receivers) that scan for these tags. The receivers detect the signals transmitted by the tags and use signal strength and other parameters to estimate the distance between the tag and the receivers. By triangulating signals from multiple receivers, the system can determine the location of the tagged object or person. Bluetooth channel sounding (CS) is a technique used in Bluetooth communication to measure time/phase delay of BT signals, such that distance between wireless devices may be estimated/measured more accurately.

Wi-Fi tracking/ranging may refer to using a Wi-Fi capable device/technology for monitoring and tracking the movement of devices within a Wi-Fi network's coverage area. Wi-Fi tracking may rely on the unique media access control (MAC) addresses of Wi-Fi-enabled devices, such as smartphones, tablets, and laptops, to identify and track them as they move within the network's range. For example, Wi-Fi tracking utilizes Wi-Fi access points (APs), which are devices that provide wireless network connectivity to devices within their range. These access points continuously broadcast Wi-Fi signals, allowing Wi-Fi-enabled devices to connect to the network. When Wi-Fi-enabled devices come within range of Wi-Fi access points, they may be configured to automatically send out probe requests, seeking available networks to connect to. Wi-Fi access points receive these probe requests and respond with probe responses containing information about the network, such as the service set identifier (SSID) and signal strength. Each Wi-Fi-enabled device may have a unique MAC address associated with its network interface. Wi-Fi tracking systems capture these MAC addresses from the probe requests and responses exchanged between devices and access points. By monitoring the signal strength and timestamps of probe requests and responses from multiple access points, Wi-Fi tracking systems may triangulate the position of Wi-Fi-enabled devices within the network's coverage area.

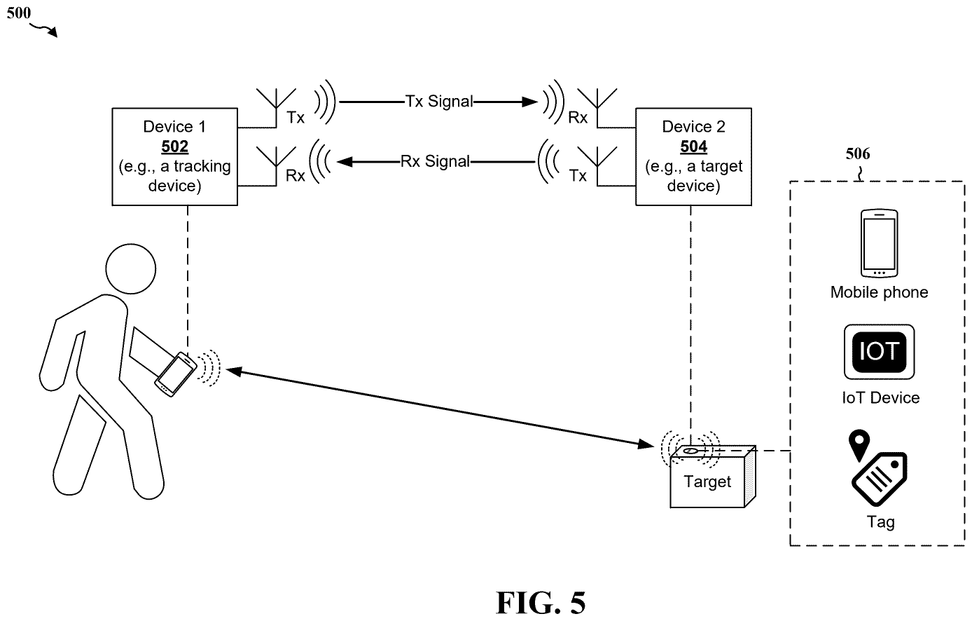

Wi-Fi ranging (e.g., 802.11mc and 802.11az) has rapidly become a key technology for several location applications. For example, some use cases that are expected to proliferate are “Find My Phone/Item/Friend” features, in which two wireless devices (e.g., two smartphones) may be configured to use Wi-Fi ranging to measure phone-to-phone distance, and then use sensor fusion to determine the (relative) direction of the wireless devices. As such, maximizing the effective range of device-to-device (e.g., phone-to-phone) may provide and ensure good user experience. Achieving good accuracy of distance measurement may also be important to ensure the use cases provide accurate direction information. However, in some scenarios, range and accuracy may sometimes be conflicting with each other (e.g., a longer range may provide a lower accuracy and a higher accuracy may provide a shorter range, etc.). FIG. 5 is a diagram 500 illustrating an example of tracking (e.g., active positioning) in accordance with various aspects of the present disclosure. A first device 502 (which may also be referred to as a “tracking device,” a “ranging device,” and/or a “finder device” for purposes of the present disclosure) may be able to locate a second device 504 (which may also be referred to as a “target” or a “target device” for purposes of the present disclosure) based on transmitting signals (which may be referred to as “transmission (Tx) signals”) to the second device 504, and receive signals (which may be referred to as “reception (Rx) signals”) from the second device 504. Depending on implementations, the Rx signals may be signals reflected from the second device 504 (e.g., based on the Tx signals) or signals generated by the second device 504. Then, based on the time of-light (ToF) of the Tx signals and the Rx signals, the first device 502 may estimate the distance of the second device 504 from the first device 502. In some configurations, if the first device is also capable of measuring the angle-of-arrival (AoA) of the Rx signals, the first device 502 may also be able to estimate the direction of the second device 504 from the first device 502 (which may be referred to as the relative direction from the first device 502). As shown at 506, the second device 504 may be a mobile phone, an Internet of Things (IoT) device, or a tag (e.g., an RFID tag), and the localizing and/or tracking of the second device 504 may be based on using Bluetooth® tracking, Wi-Fi tracking, or UWB tracking, etc.

The tracking mechanisms discussed above may have a variety of applications in real life. For example, it is common for users to lose small items (e.g., earbuds, keys, wallets, etc.) somewhere in their home, at work, or in school, and users may often rely on using tracking devices (e.g., their mobile phones) to find those lost items (e.g., earbuds, smart tags, other phones) near them. In some scenarios, a tracking device may just have the capability to identify a rough location of a target device. For example, some tracking devices may be able to just estimate that an item (e.g., a target device) is at a rough location (e.g., at home, at a specific address, at a business, etc.) based on detecting the strength of wireless signals from the item. However, in some scenarios, it may not be enough for users to know that the item is at a rough location, and the users may want to the specific location of the item, such as in a specific room (e.g., in a restroom, bedroom, kitchen, etc.) or in a specific location (e.g., under the bed, on a coach, etc.). As such, accurate positioning/tracking of the target device can be very useful for users.

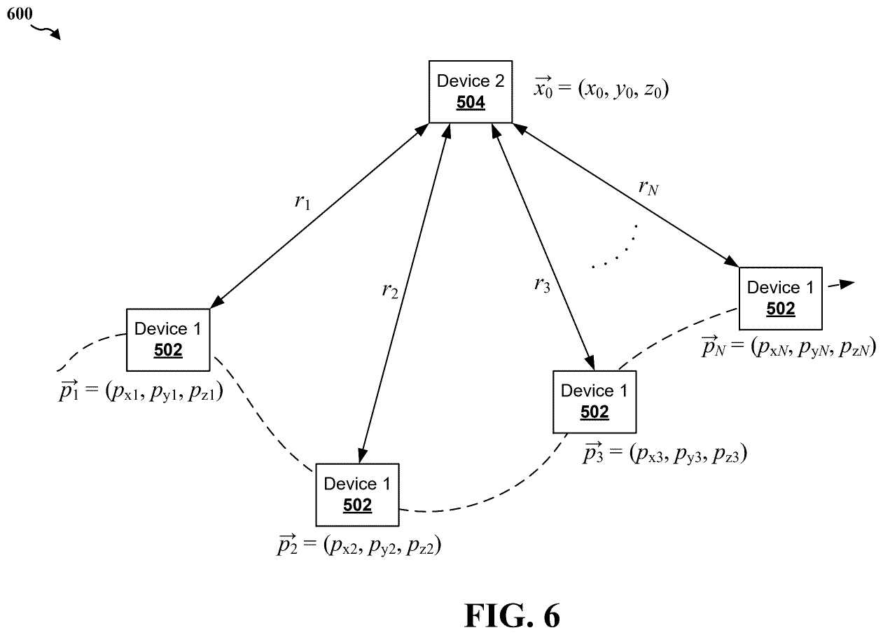

FIG. 6 is a diagram 600 illustrating an example of a tracking device moving through space while measuring time of flight (ToF) distance to a target device in accordance with various aspects of the present disclosure. In one example, a tracking device (e.g., the first device 502, a mobile phone, etc.) may be configured to perform multiple distance measurements rᵢ for a target device (e.g., the second device 504) from multiple positions \vec{p}ᵢ of the tracking based on ToF. For example, when the first device 502 (e.g., the tracking device) is at a first position \vec{p}₁, the first device 502 may measure a first distance r₁ between the first device 502 and the second device 504 (e.g., the target device) based on ToF, such as described in connection with FIG. 5. Similarly, when the first device 502 is at a second position \vec{p}₂, the first device 502 may measure a second distance r₂ between the first device 502 and the second device 504 based on ToF, and so on. Then, based on multiple distance measurements (e.g., r₁ to rₙ) at multiple positionings (e.g., \vec{p}₁ to \vec{p}ₙ), the first device 502 may determine the position of the second device 504, such as based on triangulation.

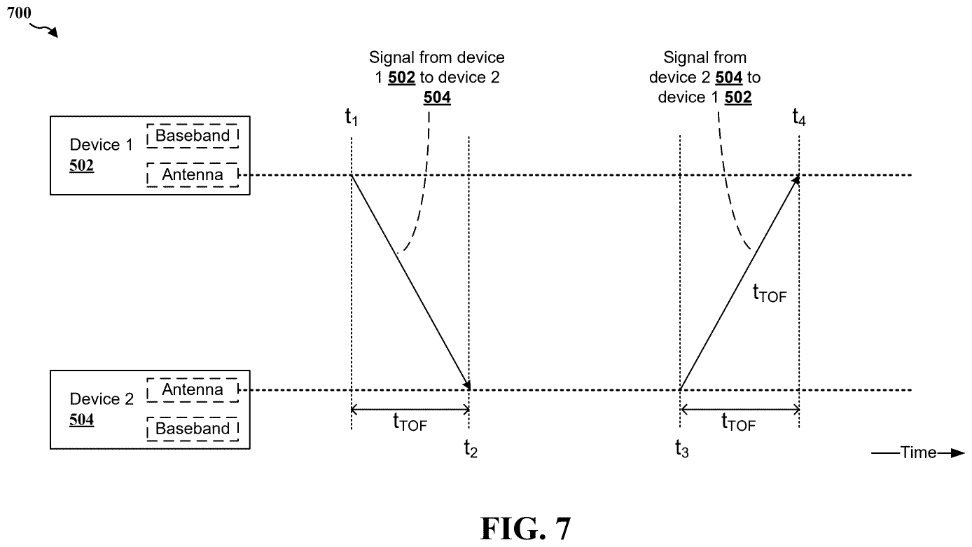

FIG. 7 is a diagram 700 illustrating an example procedure for round-trip time (RTT)/time of flight (ToF) estimation between two wireless devices in accordance with various aspects of the present disclosure. As discussed in connection with FIGS. 5 and 6, wireless tracking/ranging technologies (such as based on UWB, Wi-Fi, or BT, etc.) may rely on measuring the ToF of wireless signals sent between wireless devices. For example, an estimation of the ToF between the first device 502 and the second device 504 may be based on measuring the departure time and the arrival time for a wireless signal, then using the formula:

$${t}_{T O F} = \frac{( {t}_{4} - {t}_{1} ) - ( {t}_{3} - {t}_{2} )}{2}$$

Then the distance (d_{TOF}) between both devices may be estimated by multiplying the speed of light (c):

$${d}_{T O F} = c \cdot {t}_{T O F}$$

This formula and calculation may represent an ideal case and work fine if the times t₁, t₂, t₃, t₄ are able to be accurately measured.

While the example tracking/ranging mechanism discussed in connection with FIGS. 5 and 6 may enable a tracking device (e.g., the first device 502) to locate a target device (e.g., the second device 504) based on measuring the distances between them from multiple positions, such tracking/ranging mechanism may rely on fusion of sensor information (e.g., IMU, camera, gyroscope, etc.) with accurate round-trip time (RTT) information in order to estimate/obtain direction information. However, the accuracy of RTT (measured as standard-deviation of RTT) may have a direct impact on the directional estimate.

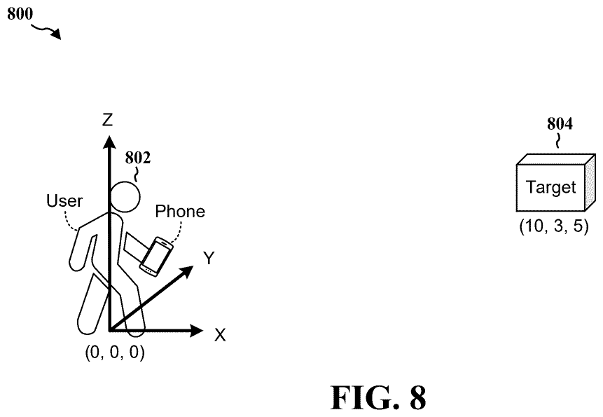

FIG. 8 is a diagram 800 illustrating an example scenario of an RTT error impacting on directional accuracy of ranging in accordance with various aspects of the present disclosure. As shown at 802, a user holding a phone may be at a three-dimensional (3D) coordinate (X, Y, Z)=(0, 0, 0), and as shown at 804, a target (e.g., to be detected by the user/phone) may be at a 3D coordinate (10, 3, 5) meters away. Assuming the user holds the phone in front of the user (e.g., 0.5 meters from the torso of the user) and makes a 360° turn while increasing the phone height by 0.5 meters (e.g., to get z-axis resolution). The user may perform this action in 5 seconds, and 5 ranging measurements may be taken by the phone per second (e.g., 25 ranging measurements in total). Assuming the time-of-flight (ToF) for the communication (e.g., for signal transmission/reception) is affected by noise with zero mean and variance σ². Then, the effect of different values of σ between 1 cm to 100 cm is simulated, where in each simulation, the Euclidian error and angular error is measured (e.g., the 3D angle, the elevation angle, and the azimuth angle, etc.). In addition, approximately 1000 simulations are performed for each value of σ.

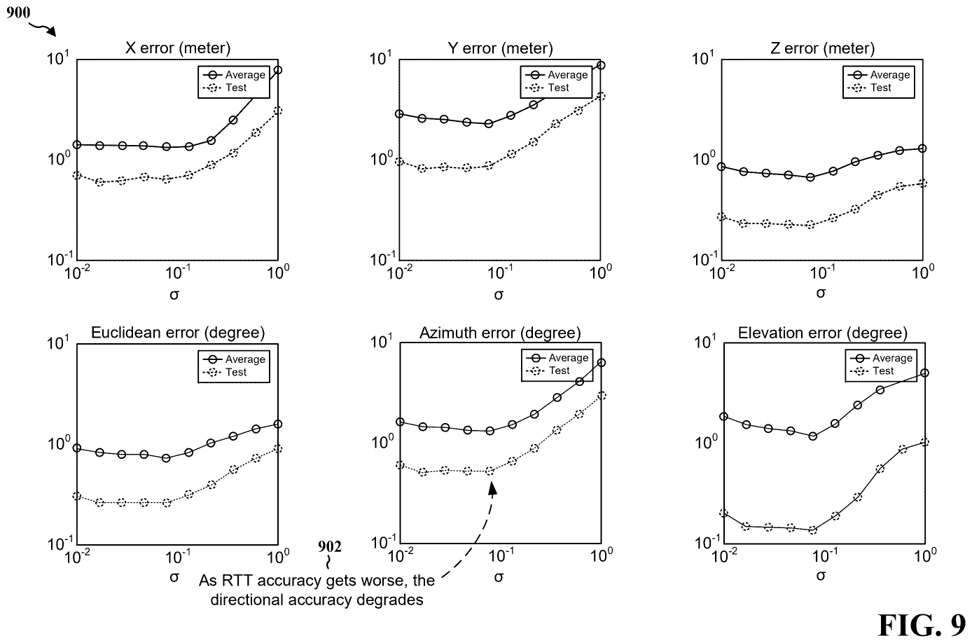

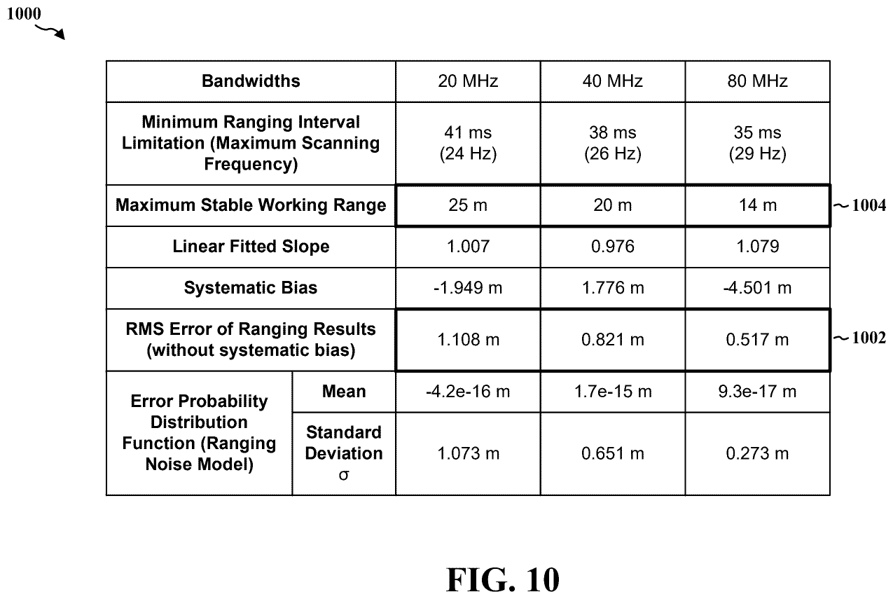

FIG. 9 is a diagram 900 illustrating an example of simulation results in accordance with various aspects of the present disclosure. Assuming the simulations discussed in connection with FIG. 8 are repeated with the same target and phone positions. Also, assuming the distance errors (e.g., the X, Y, and Z errors) illustrated in the diagram 900 are measured in meters and the angle errors (e.g., Euclidean, Azimuth, and Elevation errors) are measured in degrees. Note that each graph may have a different vertical axis. Based on the diagram 900, it may be observed that the error in z-axis is higher than in x-axis and γ-axis, which is likely because the range of vertical phone positions (0.5 meters) is less than in horizontal direction (1.0 meter). As shown at 902, as RTT accuracy for the ranging gets worse, the directional accuracy for the ranging also degrades. In this scenario, the azimuth error may be kept below 5° if σ<10 cm. FIG. 10 is a table 1000 illustrating an example of an RTT ranging performance indicator in different bandwidths in accordance with various aspects of the present disclosure. As shown at 1002, a wider packet bandwidth (e.g., 80 MHz) provides a better RTT accuracy compared to a narrower packet bandwidth (e.g., 20 MHz, 40 MHz, etc.). Thus, to obtain the best RTT accuracy, it may be suitable/desirable to use the widest packet bandwidth available for the ranging. However, as shown at 1004, a wider packet bandwidth (e.g., 80 MHz) also has a shorter maximum stable working range compared to a narrower packet bandwidth (e.g., 20 MHz, 40 MHz, etc.). In other words, to get the best possible range, it may be more suitable/desirable to use the narrowest packet bandwidth available for the ranging. For purposes of the present disclosure and in the context of ranging, such as UWB ranging, Wi-Fi ranging, and/or Bluetooth/BLE ranging, etc., a packet bandwidth may refer to the width or range of frequencies used by a ranging device for transmitting data/packet. As ranging technology may utilize a broad spectrum of frequencies (e.g., spanning several megahertz (MHz) or gigahertz (GHz) in some examples) to achieve high data rates and precise ranging capabilities, the packet bandwidth may define how much of this spectrum is allocated for transmitting each packet of data. For ease of illustration, a packet bandwidth may simply be referred to as a bandwidth (BW) depending on the context.

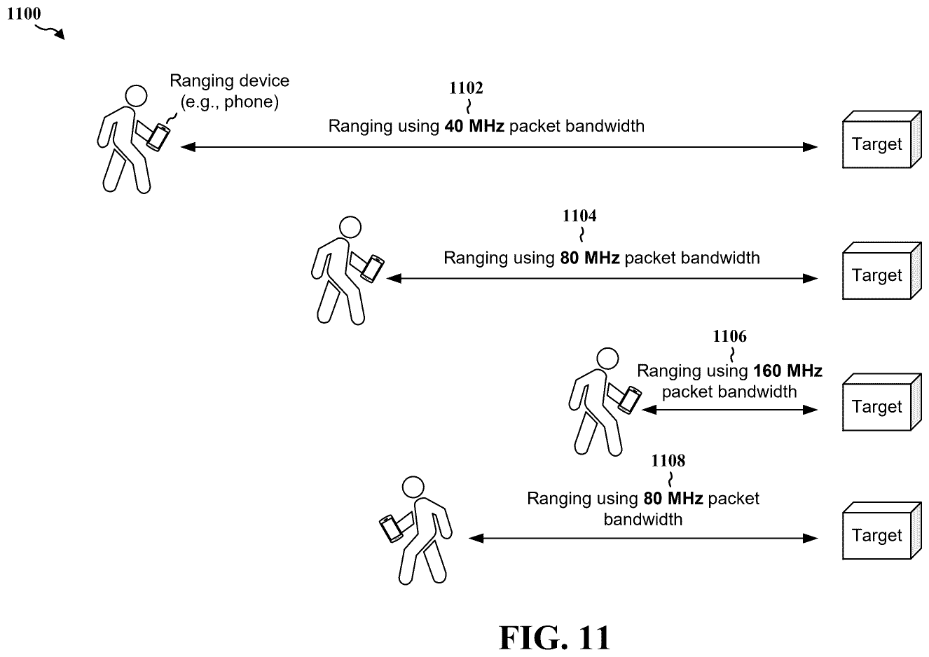

FIG. 11 is a diagram 1100 illustrating an example of performing ranging with dynamic ranging bandwidth in accordance with various aspects of the present disclosure. As discussed in connection with FIG. 10, since different bandwidths may provide different maximum stable working ranges and different RTT accuracies, the ranging performance may be improved/optimized if a ranging device is capable of dynamically selecting the most suitable (best) packet bandwidth for the environment. For purposes of the present disclosure, a ranging device may refer to a wireless device that is capable of performing ranging, such as the first device 502 discussed in connection with FIG. 5. For example, as shown at 1102, when the ranging device (e.g., a smartphone) is far away from the target (e.g., another smartphone), the ranging device may be configured to use 40 MHz packet bandwidth for the ranging. As shown at 1104, when the ranging device is moving towards the target, at some point, the ranging device may be configured to switch to 80 MHz packet bandwidth for the ranging. As shown at 1106, when the ranging device is close to the target (e.g., within a threshold distance of the target), the ranging device may be configured to switch to 160 MHz packet bandwidth for the ranging. As shown at 1108, if the ranging device moves away from the target (e.g., moves to outside of the threshold distance of the target), the ranging device may be configured to switch back to 80 MHz packet bandwidth for the ranging.

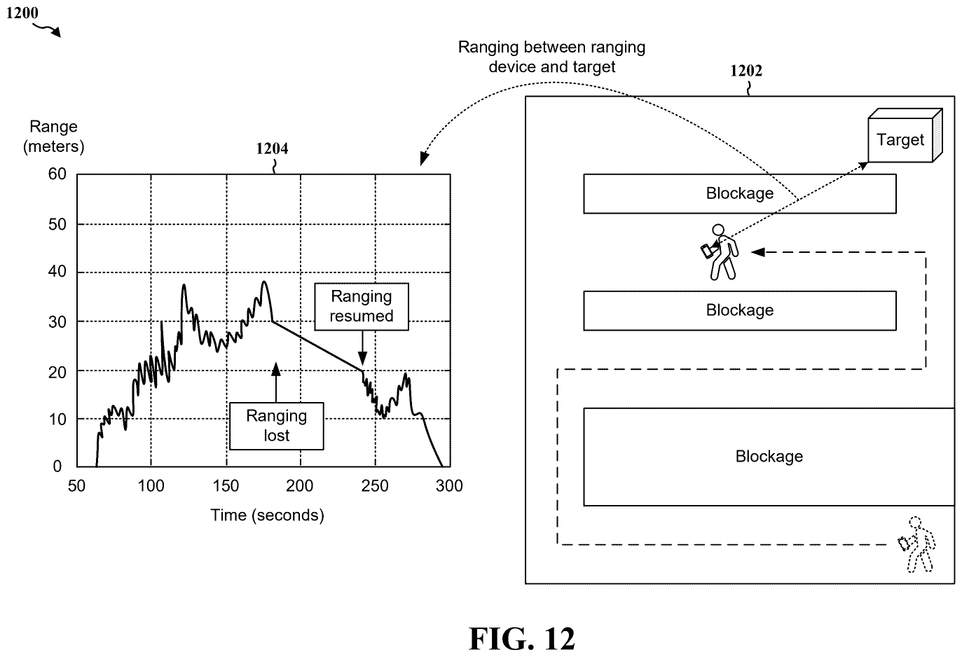

FIG. 12 is a diagram 1200 illustrating an example of a ranging lost due to weak received signal strength indicator (RSSI) in accordance with various aspects of the present disclosure. In some scenarios, for a given packet bandwidth mode, when a ranging device is performing RTT ranging (e.g., such as using Wi-Fi 802.11mc) against a target at far distances, or in non-line-of-sight (NLOS) scenarios, the connection from the ranging device to the target may drop or lost due to weak received signal strength. For example, as shown at 1202, when a ranging device is performing ranging with a target at an indoor setting (e.g., a user is using a phone to locate a merchandise based on ranging), the ranging signal between the ranging device and the target may drop when there is a blockage between the ranging device and the target (e.g., they are in an NLOS condition). As shown at 1204, an indoor RTT-based ranging results between the ranging device and the target (e.g., using a single ranging packet bandwidth such as 80 MHz) may show that at about 30 meters of range, ranging between the ranging device and the target is lost due to weak ranging signals. Then, after the ranging device moves to be around 20 meters of the target, the ranging connection was restored and the ranging was resumed. In this example, the ranging packet bandwidth is configured to be not adaptive (e.g., not dynamically changed).

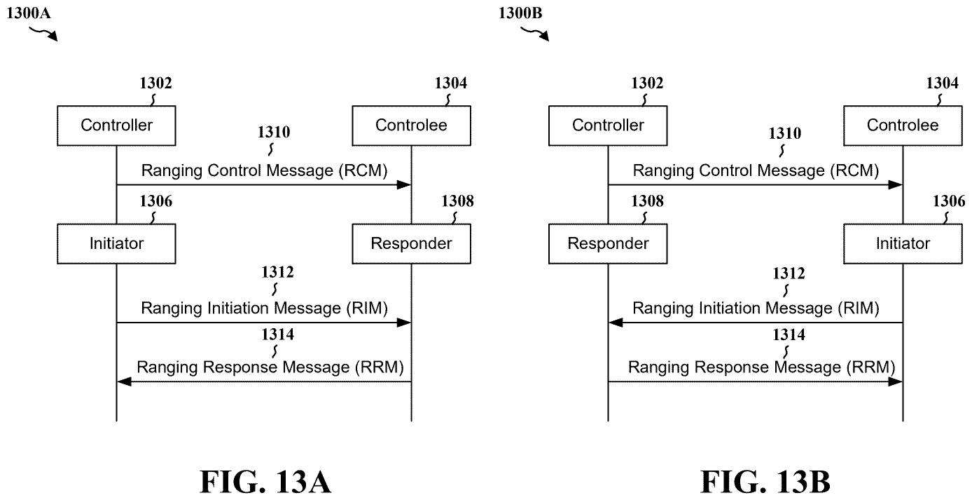

FIGS. 13A and 13B are diagrams 1300A and 1300B, respectively, illustrating example roles (e.g., logical/network entities) in an UWB ranging operation in accordance with various aspects of the present disclosure. In one example, an UWB ranging operation may be performed by a set of enhanced ranging devices (ERDEVs) that is capable of communicating with each other via UWB (e.g., transmitting/receiving UWB signals or waveforms) and also via non-UWB (which may be referred to as an out-of-band (OOB) communication, e.g., Bluetooth communication, Wi-Fi communication, etc.). In some examples, the ERDEVs may be a set of base stations, components of a base stations, a set of UEs, components of a UE, or a combination thereof.

Referring to the diagrams 1300A and 1300B, an UWB ranging operation may include multiple entities (or ERDEVs), such as a controller 1302, a controlee 1304, an initiator 1306, and a responder 1308. The controller 1302 and the controlee 1304 may be logical entities that are at a higher layer of a protocol stack, such as an application that is responsible for transmitting control messages (e.g., an application running on a device). On the other hand, the initiator 1306 and the responder 1308 may be operating at a physical (PHY) layer or a medium access control (MAC) layer, where signals may be exchanged between the initiator 1306 and the responder 1308 over the air based on UWB.

For example, as shown at 1310, the controller 1302 may be an ERDEV that controls an UWB ranging operation and defines the UWB ranging operation parameters for one or more controlees (e.g., the controlee 1304) by sending a ranging control message (RCM) to the one or more controlees. The controlee 1304 may be an ERDEV that utilizes the UWB ranging operation parameters received from the controller 1302 in the RCM.

As shown at 1312, the initiator 1306 may be an ERDEV that follows the RCM and initiates a ranging message exchange by sending a first ranging message of the exchange (e.g., a ranging initiation message (RIM)) to one or more responders (e.g., the responder 1308). Either a controller or a controlee may be an initiator. For example, as shown by the diagram 1300A of FIG. 13A, the controller 1302 may be the initiator 1306, and as shown by the diagram 1300B of FIG. 13B, the controlee 1304 may be the initiator 1306.

As shown at 1314, the responder 1308 may be an ERDEV that responds to the RIM received from the initiator 1306. For example, in response to the RIM, the responder 1308 may transmit a ranging response message (RRM) to the initiator 1306. In one example, based on the RRM, the initiator 1306 may determine a distance between the initiator 1306 and the responder 1308, such as based on the time of flight (ToF) of the RRM. For purposes of the present disclosure, a “ranging message” may refer to any types of messages that is transmitted during a ranging session, such as an UWB ranging session. The RRM may refer to a message that is transmitted in response to an RIM.

In some implementations, the transmission of the RCM at 1310 may be based on OOB communications (e.g., non-UWB communications, such as based on Bluetooth communications, Wi-Fi communications, or other types of RF communications), whereas the transmission of the ranging messages (e.g., the RIM and/or the RRM, etc.) at 1312 and 1314 may be based on UWB (e.g., which may also be referred to as “in-band” communications). For purposes of the present disclosure, an UWB session may refer to a ranging session that is based on UWB. While aspects presented herein may use UWB as examples, aspects presented herein may also apply to sidelink or other types of ranging operations (e.g., ranging based on Wi-Fi, Bluetooth, 4G/13G/6G signals, etc.), which may also be considered as within the scope of the present disclosure.

As discussed in connection with FIGS. 10 to 12, since RTT ranging accuracy may improve with larger bandwidths (BWs), it may be suitable/desired to use the highest BW(s) possible between the ranging device and the target for the best possible ranging accuracy. However, larger BWs may also result in a higher noise power. For example, as shown by the Table 2 below, for the same temperature, 160 MHz ranging packet bandwidth may result in 9 dB more noise power than 20 MHz ranging packet bandwidth. In other words, if the operating bandwidth is reduced from 160 MHz to 20 MHz, there may be an increase of 9 dB in the signal-to-noise ratio (SNR) due to the reduction in total noise power. This extra 9 dB may mean reaching further distances (e.g., the maximum ranging distance may be increased).

TABLE 2
Example Thermal
Noise Power for
Different Bandwidth

| | | Thermal | |
|---|---|---|---|
| Bandwidth | | Noise | |
| (MHz) | | Power (Pₙ) | |
| 20 | MHZ | −100.7 | dBm |
| 160 | MHZ | −91.6 | dBm |

The thermal noise power (Pₙ) may be calculated based on:

$${P}_{n} = 10 {log}_{10} ( \frac{kBT}{1 mW} )$$

where T is the temperature in Kelvin, B is the bandwidth in Hz, and k=Boltzmann's constant (1.38064852×10⁻²³ m² kg s⁻² K⁻¹).

In addition to the improved SNR, lowering the packet bandwidth mode the ranging device is operating in may also result in the potential for increasing the transmit power while still meeting the error vector magnitude (EVM) specifications and being mask compliant. For example, the lower the BW the more Tx power may be used by the ranging device.

Aspects presented herein may improve the overall performance and accuracy of ranging by enabling a ranging device (which may be referred to as a first UE or a first wireless device in some examples) to perform ranging with a target (which may be referred to as a second UE or a second wireless device in some examples) with dynamic packet bandwidth. In one aspect, at far ranges or in scenarios where received signal strength indicator (RSSI) is very low/poor, the ranging device and the target may negotiate or re-negotiate the choice of channel BW (which may simply be referred to as the “BW” depending on the context and for ease of illustration) to achieve ranging which may not be possible otherwise. For example, the ranging device and the target may agree to drop the BW mode totally to 20 MHz, in a one-mode step (e.g., 160 to 80 MHz), or in a more intelligent manner (discussed below). Lowering the BW may enable the ranging device to reach further ranges as discussed above. Even if the ranging accuracy drops, it may be tolerated in some occasions as ranging error at true large distances may have little effect/impact compared to short distances. For example, a 5 meter error may be tolerated when the true distance is 110 meters but may not be as tolerated if the true distance is 10 meters. When ranging is happening at a low BW mode and the user is moving roughly toward the target device, accuracy becomes the goal and the ranging device may be configured to switch to BW modes that may result in higher accuracy if/when possible. Aspects presented herein may enable a ranging device to sacrifice accuracy for the benefit of maintaining ranging capabilities. Then, when ranging is maintained, albeit at low accuracy, the ranging device and the target may move closer and/or in the right direction until RSSI becomes better and higher ranging accuracy can be achieved through switching back to the higher BW mode.

Aspects presented herein provide various mechanisms for dynamic packet BW selection to improve ranging capabilities for ranging devices at far distances or in scenarios with higher path loss/interference. In one aspect, a ranging device (and a target) may be configured to iteratively drop the packet BW until detection is achieved and ranging is possible. This configuration may help in enabling ranging in scenarios where it is either lost or not possible. Then, after detection and ranging is achieved at the (most probably) lower BW by the ranging device and the target, the ranging device (and the target) may be configured to apply an RSSI-based packet BW selection for improved ranging. This configuration may improve the ranging accuracy/performance. In another aspect of the present disclosure, the ranging device (and the target) may be configured to rely on prior information about the maximum possible supported distance and the distance error distribution to guide packet BW selection. In another aspect of the present disclosure, the ranging device (and the target) may also be configured to use time-of-arrival (ToA) indicator and relative change(s) in RSSI to decide on when to change the packet BW.

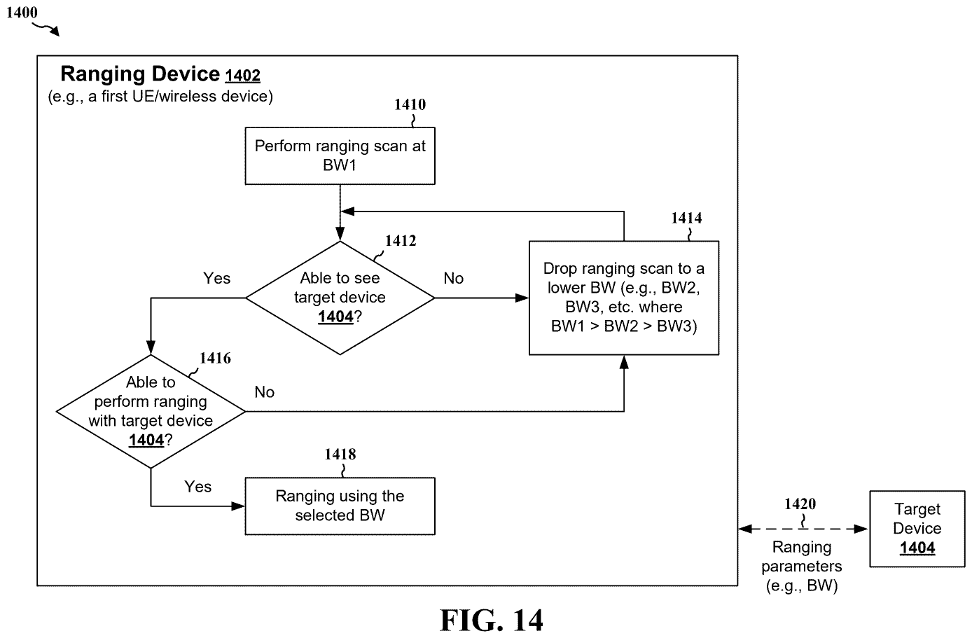

FIG. 14 is a diagram 1400 illustrating an example of an iterative packet BW selection to enable ranging in far distances and/or high pathloss scenarios in accordance with various aspects of the present disclosure. Aspects presented herein may enable a ranging device 1402 (e.g., a first UE, a first wireless, etc.) to perform ranging with a target device 1404 (e.g., a second UE, a second wireless, etc.) at far distances. The same process may be repeated by the ranging device 1402 across multiple (e.g., more than two) bandwidth modes until ranging becomes possible.

As an illustration, at 1410, the ranging device 1402 may be configured to perform a ranging scan/detection for the target device 1404 based on using a first packet BW (e.g., 160 MHz). For purposes of the present disclosure and in the context of ranging, scan/discover may refer to a process of searching/detecting for available signals (e.g., from a wireless network, a target, or a positioning beacon, etc.).

At 1412, the ranging device 1402 may determine whether it is able to see/detect the target device 1404 based on using the first packet BW (e.g., 160 MHz) for the ranging scan. As shown at 1414, if the ranging device 1402 is unable to see/detect the target device 1404 based on using the first packet BW (e.g., 160 MHz), the ranging device 1402 may be configured to switch to a lower packet BW to perform the ranging scan, such as using a second packet BW (e.g., 80 MHz) that is lower than the first packet BW (e.g., 160 MHz). Similarly, after switching the second packet BW (e.g., 80 MHz), the ranging device 1402 may again determine whether it is able to see/detect the target device 1404 based on using the second packet BW (e.g., 80 MHz) for the ranging scan. If the ranging device 1402 is still unable to see/detect the target device 1404 based on using the second packet BW (e.g., 80 MHz), the ranging device 1402 may be configured to switch to another lower packet BW to perform the ranging scan, such as using a third packet BW (e.g., 20 MHz) that is lower than the second packet BW (e.g., 80 MHz), etc. The ranging device 1402 may be configured to repeat this process (e.g., dropping packet BW for the ranging scan) until the ranging device 1402 is able to see/detect the target device 1404. In some implementations, the ranging device 1402 may be configured to abort the ranging session if the ranging device 1402 is unable to see/detect the target device 1404 using the lowest packet BW available for a defined period of time (not shown in the diagram 1400).

On the other hand, as shown at 1416, if the ranging device 1402 is able to see/detect the target device 1404 when using a particular packet BW, the ranging device 1402 may next determine whether it is able to perform ranging with the target device 1404 based on using that particular packet BW. In some implementations, prior to determining whether it is able to perform ranging with the target device 1404, the ranging device 1402 may also (optionally) be configured to perform association with the target device 1404, where the ranging device 1402 may communicate/exchange parameters related to the ranging with the target device 1404, such as the packet BW that is to be used by the ranging device 1402 for the ranging.

As shown at 1414, if the ranging device 1402 is unable to perform the ranging with the target device 1404 based on using that particular packet BW, the ranging device 1402 may be configured to switch to a lower packet BW to perform the ranging (which may or may not include repeating the process 1412). For example, assuming the ranging device 1402 is able to see/detect the target device 1404 when using the second packet BW (e.g., 80 MHz) but is unable to perform the ranging with the target device 1404 using the second packet BW (e.g., 80 MHz), the ranging device 1402 may switch to another lower packet BW to perform the ranging, such as using a third packet BW (e.g., 20 MHz) that is lower than the second packet BW (e.g., 80 MHz). In some implementations, the ranging device 1402 may be configured to repeat the process 1412 (e.g., determine whether it is able to see/detect the target device 1404 using the third packet BW. In some implementations, the ranging device 1402 may be configured to just determine whether it is able to perform the ranging with the target device 1404 based on using the third packet BW (e.g., without repeating the process 1412).

As shown at 1418, if the ranging device 1402 is able to perform the ranging with the target device 1404 based on using a particular packet BW, the ranging device 1402 may be configured to use that particular packet BW for the ranging. During the ranging, the target device 1404 may dynamically switch the packet BW for the ranging (based on aspects discussed below—the dynamic packet BW selection), and the target device 1404 may also be configured to notify the target device 1404 when there is a packet BW change/switch. For example, as shown at 1420, depending on implementations and/or the wireless communication protocol (e.g., UWB, Wi-Fi, Bluetooth, etc.) used for the ranging, the ranging device 1402 may be configured to exchange ranging related parameters with the target device 1404 during and/or prior to the ranging, such as described in connection with FIGS. 13A and 13B. The ranging parameters may include packet BW to be used (e.g., if the ranging device 1402 changes the packet BW, the ranging device 1402 may be configured to notify the target device 1404 regarding the change), the wireless communication protocol to be used for the ranging (e.g., in some scenarios parameters to be used for the ranging may be communicated using a different wireless communication protocol than the ranging), and/or an estimated distance between the ranging device 1402 and the target device 1404 based on the ranging if available (e.g., sometimes just one of the ranging device 1402 or the target device 1404 may be able to estimate the distance between them, and may be configured to notify the other device about the estimated distance during the ranging), etc.

Depending on implementations, when the ranging device 1402 (or the target device 1404 in some scenarios) is acting like a soft AP (SAP), the ranging device 1402 may dictate what the target device 1404 uses for the packet BW. If the target device 1404 is capable of supporting that packet BW, the target device 1404 may send packets (to the ranging device 1402) following that packet BW. In some scenarios, both devices may communicate/range using one specific packet BW (or, simply BW). However, if one of the devices or both is configured to implement the packet BW switching/selection described herein, then the main device (SAP) (e.g., the ranging device 1402) may tell/request the other device (e.g., the target device 1404) to switch its packets' BW to lower/higher BW modes as long as that SAP is capable of supporting it. For example, if an SAP is capable of supporting up to 320 MHz packet BW for the ranging, and the other device (e.g., assuming its an initiator) is also capable of supporting up to 320 MHz for the ranging, then they can both try ranging on 320 MHz. However, SAP may tell the initiator that for the next set of packets, send packets using 20, 80, or 160 MHz, etc.

In some implementations, just packet BW may be changed in real time/subsequent packets. The actual physical channel BW may be configured to stay at the BW in which the devices are operating in. However, in general, devices may be booted to operate in their highest BW. For example, in Wi-Fi6, an access point (AP) may be configured to boot up in 160 MHz (i.e., the highest packet BW), and then based on the capability of each station (e.g., a mobile phone, a tablet, etc.), the AP may communicate accordingly, e.g., the mobile phone may be able to work with 160 MHz but an old/small/low energy device may just have 40 MHz support. The AP may still perform ranging with this old/small/low energy device using packets of BW 40 Mhz. In another aspect of the present disclosure, a ranging device (e.g., the ranging device 1402) may be configured to perform received signal strength indicator (RSSI)-based packet BW selection to improve the ranging accuracy. For example, the ranging device may be configured/provided with a set of ranging for different ranging bandwidths, such as shown by Table 4 below.

TABLE 4
Example ranging factors for different bandwidths

| BW | 2G BW | 5G BW | 5G BW | 5G BW | 5G BW |
|---|---|---|---|---|---|
| Modes | 20 MHz | 20 MHz | 40 MHz | 80 MHz | 160 MHZ |
| Ranging | β₅ | β₄ | β₃ | β₂ | β₁ |
| factor | | | | | |

In other words, the ranging factors beta (B) are known by the ranging device, which may be obtained by the ranging device from the standard (e.g., minimum reception (Rx) sensitivity in theory) and/or from a chip vendor (e.g., minimum Rx sensitivity measured at different temperatures), etc.

As a demonstration, assuming the ranging device 1402 discussed in connection with FIG. 14 is performing the ranging with the target device 1404 using the third bandwidth (e.g., 20 MHz). The ranging device 1402 (e.g., while performing the ranging with the target device 1404) may be configured to compare the RSSI (e.g., of the ranging signals) at the third bandwidth (e.g., 20 MHz) to a predetermined threshold (discussed below). The ranging device 1402 may be configured to start with comparing to a highest ranging packet BW available (e.g., the first packet BW of 160 MHz) (to get the highest accuracy possible) and fall to the next available packet BW in case the condition is not met. Out-of-Band (OOB) RSSI based decisions may also be implemented if possible.

In other words, multiple thresholds may be configured/defined for each packet BW supported by the ranging device 1402. Then, the ranging device 1402 may switch to a different packet BW based on the RSSI of the current packet BW. Below is an example algorithm for the RSS-based dynamic packet BW selection described herein. For 20 MHz packet BW (denoted by BW₂₀), based on the measured RSSI at 20 MHz (denoted by RSSI₂₀):

$if {RSSI}_{20} \geq ( {β}_{1} * {RSSI}_{min , range}^{160} ) then switch to {BW}_{160}$
$else if {RSSI}_{20} \geq ( {β}_{2} * {RSSI}_{min , range}^{80} ) then switch to {BW}_{80}$
$else if {RSSI}_{20} \geq ( {β}_{3} * {RSSI}_{min , range}^{40} ) then switch to {BW}_{40}$
else stay in BW₂₀
end if

Based on using this example algorithm, the best possible scenario may be the ranging device 1402 is able to immediately move to the highest available BW (e.g., 160 MHz, denoted by BW₁₆₀) in the next time slot, and the worst possible scenario is the ranging device 1402 stays in the current or the lowest BW (e.g., 20 MHz, BW₂₀). Other scenarios may involve moving to 80 MHz (e.g., BW₈₀) after 2 time slots or moving to 40 MHz (BW₄₀) after 3 time slots, etc. In other words, if the RSSI of the 20 MHz packet BW exceeds a first threshold, the ranging device may switch to 160 MHz packet BW. However, if the RSSI of the 20 MHz packet BW does not exceed the first threshold but exceeds a second threshold, the ranging device may switch to 80 MHz packet BW. Similarly, if the RSSI of the 20 MHz packet BW does not exceed the second threshold as well but exceeds a third threshold, the ranging device may switch to 40 MHz packet BW. If the RSSI of the 20 MHz packet BW does not exceed any of the thresholds, then the ranging device may maintain using the current packet BW (e.g., not switching to a different packet BW).

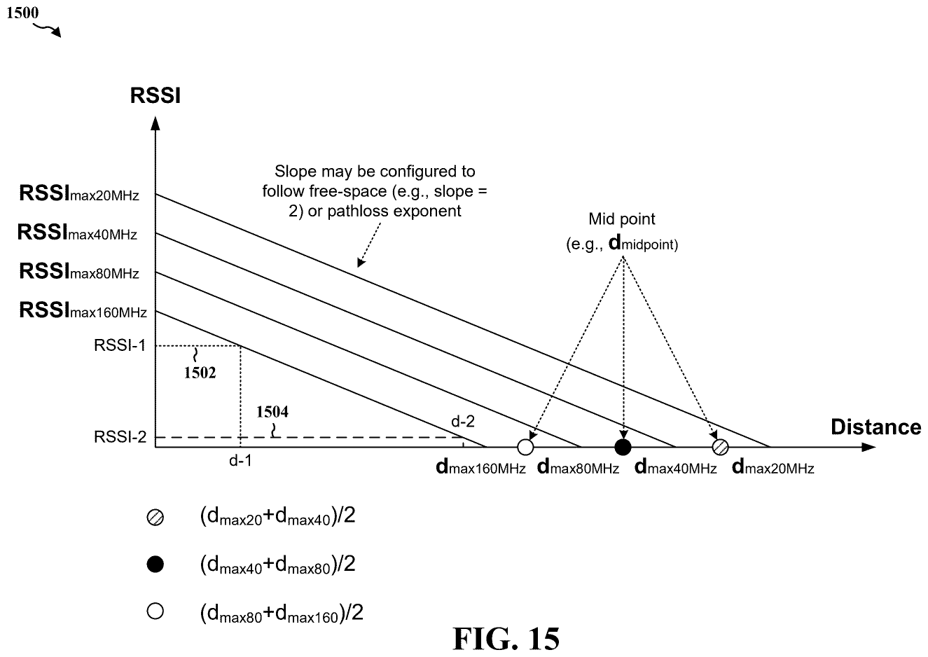

FIG. 15 is a diagram 1500 illustrating an example of a maximum distance-informed packet BW selection for ranging in accordance with various aspects of the present disclosure. In another aspect of the present disclosure, a ranging device (e.g., the ranging device 1402) may be configured to select packet BW for ranging based on a maximum supported ranging distance associated with different RSSs.

As there may be an inverse relationship between received power and distance, the reception Rx power (for ranging signals) of a given packet BW may be inversely proportional to the maximum supported ranging distance. The ranging device may obtain the maximum supported ranging distance for every packet BW or BW mode (e.g., based on a pre-configuration, detection, or performing rate versus range (RvRs) tests, etc.). Then, the ranging device may compare a measured/estimated distance between the ranging device and the target (e.g., obtained/estimated during the ranging) to the mid-point distance between these maximum supported ranging distances to select a corresponding packet BW for the ranging. For example, as shown at 1502, when the RSSI is at RSS-1 (which is higher than RSS-2 below), it may indicate that the ranging device is far away from the maximum possible supported distance. Therefore, ranging is likely to be resuming on 160 MHz. However, as shown at 1504, when the RSSI is at RSS-2, which is near the end line of the 160 MHz, it may indicate the ranging device is very close to not being able to support the ranging in 160 MHz. Thus, it may be more suitable to use 80 MHz for the ranging. An example algorithm for selecting packet BW based on a measured/estimated distance (d*) may be:

```
if d* ≥ nearest d_{midpoint} then
  select BW corresponding to the next d_{midpoint} to the right
elsera
  select BW to the left
  if ranging is not possible then
        select BW corresponding to the next d_{midpoint} to the right
  else
    stay in newly selected BW until d* changes by
      X = d_{maxAtBWLeft-}d_{maxAtBWright}
  end if
end if
```

In some implementations, the example algorithm above may assume a probability of 1 or 0 for a certain distance to be covered by a packet BW. The example algorithm may also assume the measured distance belongs to a single point. However, in reality or in an actual implementation, the reported/measured/estimated distance may vary and may include an error. In some scenarios, this error may follow a Gaussian/Normal distribution. Also, the maximum reported distance may also depend on the changes in surrounding environment as the ranging device and/or the target device may move and/or the RSSI may fluctuate. As such, it may be assumed that the maximum supported distance also follows a Gaussian/Normal distribution. Therefore, in another aspect of the present disclosure, the ranging device may be configured to use or implemented with a probability approach where the decision to pick/select the packet BW mode is based on the intersection and/or area of overlap between two distributions.

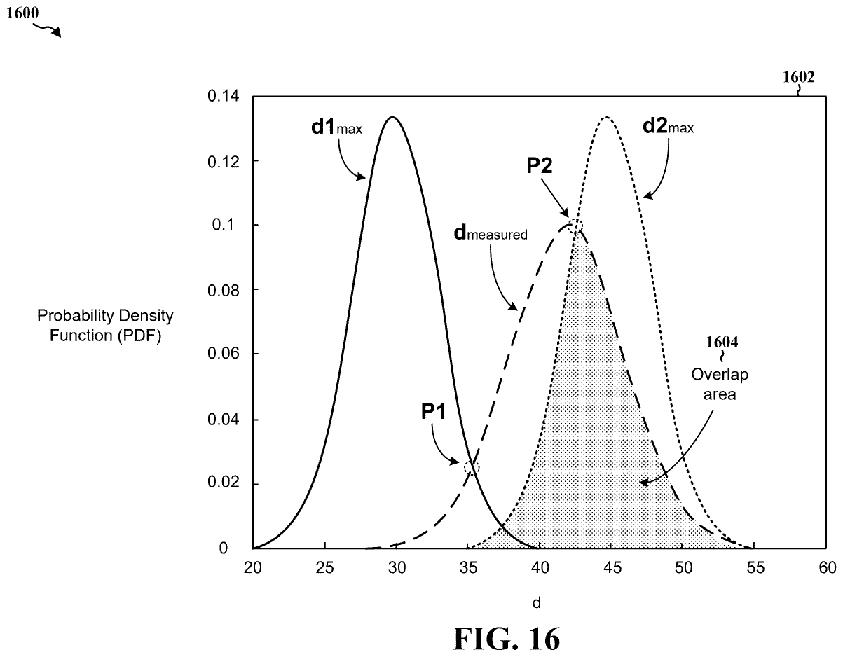

FIG. 16 is a diagram 1600 illustrating an example of selecting the packet BW for ranging based on an intersection and/or an area of overlap between two distributions in accordance with various aspects of the present disclosure. In one example, the overlap area between the observation/measured distance distribution and the neighboring distributions belonging to the maximum distance supported is shown at 1602.

A ranging device (e.g., the ranging device 1402) may be configured to select/choose the most likely supported packet BW mode based on (1) the area of overlap and/or (2) the intersection point. For example, if X₁ and X₂ are two normally distributed random variables representing d1ₘₐₓ (e.g., the maximum supported ranging distances of a first BW) and the measured d distribution

$${X}_{1} ∼ N ( {μ}_{1} , {σ}_{1}^{2} )$$

$${X}_{2} ∼ N ( {μ}_{2} , {σ}_{2}^{2} )$$

The area of overlap may be obtained based on:

$$P ( {X}_{1} > c ) + P ( {X}_{2} < c ) = 1 - {F}_{1} ( c ) + {F}_{2} ( c ) = 1 - \frac{1}{2} erf ( \frac{c - {μ}_{1}}{\sqrt{2} {σ}_{1}} ) + \frac{1}{2} erf ( \frac{c - {μ}_{2}}{\sqrt{2} {σ}_{2}} )$$

where c is the intersection point, which may be found based on:

$$c = \frac{{μ}_{2} {σ}_{1}^{2} - {σ}_{2} ( {μ}_{1} {σ}_{2} + {σ}_{1} \sqrt{{( {μ}_{1} - {μ}_{2} )}^{2} + 2 ( {σ}_{1}^{2} - {σ}_{2}^{2} ) log ( \frac{{σ}_{1}}{{σ}_{2}} )} )}{{σ}_{1}^{2} - {σ}_{2}^{2}}$$

As shown at 1604, the area of overlap between the distribution belonging to the measured/estimated distance d_{measured} and d2ₘₐₓ (e.g., the maximum supported ranging distances of a second BW) is 0.27 which is greater than 0.085 (e.g., the overlap between d_{measured} and d1ₘₐₓ). Hence, the ranging device may be configured to choose the corresponding BW (e.g., BW X₂) as the packet BW for the ranging. In other words, instead of probability of 1 or 0 (e.g., may be supported or not), for any dₘₐₓ, it likely follows a certain distribution, e.g., Normal. So, if RTT with the value X1 is measured and it follows a Normal distribution, then the ranging device may compare it to the next/neighbor maximum supported distance. Assuming the RTT with the value X2 also follows some distribution (here, the Normal distribution) and compute overlap/intersection. So, if a measurement/observation lies between two possible supported distances, the overlap between the measured data point distribution and the two neighboring dₘₐₓ distributions may be measured.

In some examples, if the area of overlap is comparable between the two, i.e., the distribution of d_{measured} overlaps almost equally with the two BW modes, then it may be left to the implementation of the ranging device. For example, if ranging reliability is desired, the ranging device may be configured to move to the right (e.g., to a lower BW mode, lower accuracy, higher range). However, if ranging accuracy is desired, the ranging device may be configured to move to the left (e.g., to a higher BW mode, higher accuracy, lower range).

In another aspect of the present disclosure, a ranging device (e.g., the ranging device 1402) may be configured to perform dynamic channel/packet BW selection based on time of arrival indicator and relative received signal strength indicator (RSSI) changes. For example, the ranging device may be configured to dictate the channel/packet BW to be selected for the ranging (with the target device) according to a time of arrival indicator and a relative change in RSSI. In one example, the time-of-arrival indicator may be implemented in a way that it is capable of indicating whether the estimate of the time of arrival of the signal may be considered as valid or invalid.

As an illustration, there may be multiple possible scenarios where the ranging device may have the capability to dictate the packet BW for the ranging (and also indicate to the target device). In one implementation, for a current acknowledged (ACK) frame, if at least one time-of-arrival indicator indicates the estimate of the time of arrival of the signal is invalid, the ranging device may be configured to reduce the packet BW of the next fine timing measurement (FTM) packet to half of the current FTM packet, where FTM may refer to a type of packet used in time of flight (ToF) ranging techniques, such as in UWB communication systems. In the 11mc FTM protocol, timing measurements may be configured to be collected in bursts. During each burst, multiple pairs of FTM and ACK frames are exchanged between two devices (e.g., between the ranging device 1402 and the target device 1404). This sequence may result in the terms “current received ACK” and “next received ACK” from a responder's perspective. The ranging device may also be configured to capture the RSSI of the current ACK frame and store it as a low RSSI (RSSI_low). In another scenario, for the current ACK frame, if all time-of-arrival indicators indicate the estimate of the time of arrival of the signal is valid (i.e., indicating they are healthy), and if the RSSI of the current ACK (RSSI_current) is less than (RSSI_low plus a defined threshold: RSSI_low+threshold), the ranging device may be configured to maintain the BW of the next FTM packet at the same value as the current FTM packet. In another scenario, for the current ACK frame, if all time-of-arrival indicators indicate the estimate of the time of arrival of the signal is valid (i.e., indicating they are healthy), and if the RSSI of the current ACK (RSSI_current) is greater than or equal to (RSSI_low+threshold), the ranging device may be configured to increase the bandwidth of the next FTM packet to twice of the current FTM. In other words, based on the RSSI of the frame and the time-of-arrival indicator(s), the ranging device may adjust the packet BW for ranging accordingly.

In another aspect of the present disclosure, when the ranging is performed based on using 802.11mc FTM based RTT, an initiator (e.g., the ranging device as discussed in connection with FIGS. 13A and 13B) may have the estimated distance and may use the estimated distance, TOA indicator, and/or RSSI to determine the suitable/desired FTM bandwidth (e.g., the packet BW for ranging). Then, the initiator may be specified to inform a responder (e.g., the target device) of the suitable/desired FTM bandwidth by sending a fine timing measurement request (FTMR) frame. In response, the responder may transmit the FTM frames and decide their bandwidth. For example, the responder may use TOA indicator and/or RSSI to decide the bandwidth of the next FTM frames but may not use the estimated distance.

In another example, when the ranging is performed based on using 802.11az/802.11bk null data packet (NDP) based RTT, non-trigger-based, an initiator (e.g., the ranging device) may have the estimated distance and may be configured to decide the bandwidth of the NDPs. For example, the initiator may use the estimated distance, TOA indicator, and/or RSSI to decide the bandwidth of the next NDP frames. The responder (e.g., the target) may also know the estimated distance if initiator-to-responder (I2R) location measurement report (LMR) is negotiated, and the responder may use the estimated distance (if I2R LMR is negotiated), TOA indicator, and/or RSSI to determine/know the suitable/desired NDP bandwidth. However, the responder may be specified to inform the initiator of the suitable/desired NDP bandwidth by sending an FTM frame.

In another example, when the ranging is performed based on using 802.11az/802.11bk NDP based RTT, trigger-based, an initiator (e.g., the ranging device) may have the estimated distance and may use the estimated distance, TOA indicator, and/or RSSI to determine/know the suitable/desired NDP bandwidth. Similarly, the initiator may be specified to inform the responder of the suitable/desired NDP bandwidth by sending an FTMR frame. In response, the responder may decide the bandwidth of the NDPs and may also determine/know the estimated distance if I2R LMR is negotiated. The responder may use the estimated distance (if I2R LMR is negotiated), TOA indicator, and/or RSSI to decide the bandwidth of the next NDP frames.

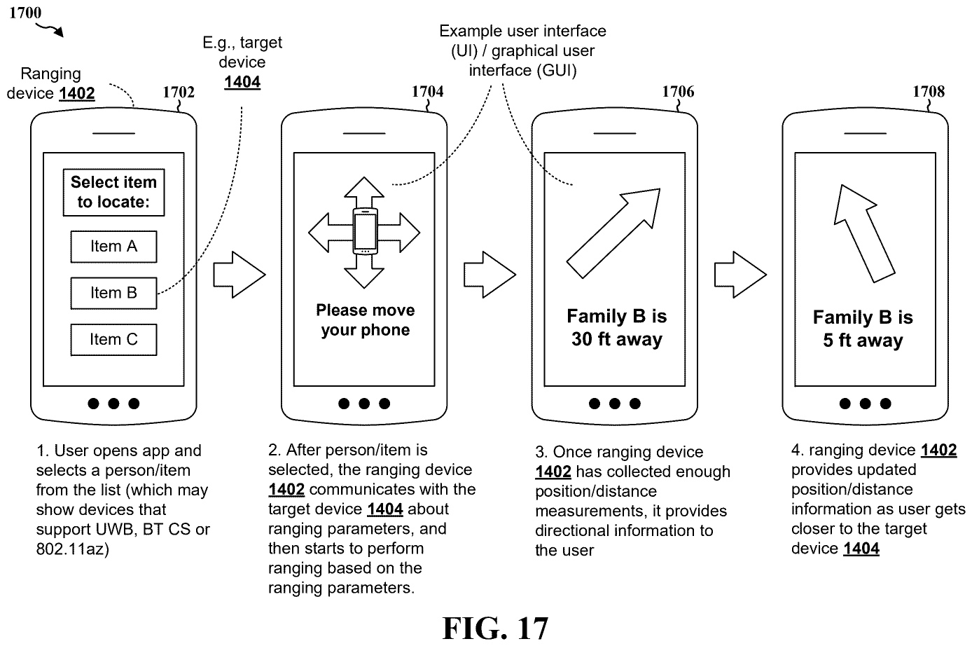

FIG. 17 is a diagram 1700 illustrating an example user experience of a ranging device locating a target device in accordance with various aspects of the present disclosure. As shown at 1702, the ranging device 1402 (e.g., a first UE, wireless device, or mobile phone, etc.) or an application running on the ranging device 1402 may instruct the user to select an item (e.g., from a list of detected items) for ranging. As shown at 1704, after the user selects an item (e.g., item B) that is associated with a target device 1404 (e.g., a second UE, wireless device, or mobile phone, etc.), the ranging device 1402 may communicate with the target device 1404 about ranging parameters, and then start to perform ranging based on the communicated ranging parameters, such as described in connection with FIGS. 5 to 7. For example, the ranging device 1402 may start measuring the distance between the ranging device 1402 and the target device 1404 based on exchanging ranging signals. As shown at 1706, after the ranging device 1402 has collected sufficient position/distance measurements, the ranging device 1402 may start providing directional information of the target device 1404 to the user, such as by showing the direction and the distance of the target device 1404 with respect to the ranging device 1402. Then, as shown at 1708, the ranging device 1402 may continue to update the directional information of the target device 1404 as the user moves, and may stop the update after the user locates the target device 1404 (e.g., after the ranging device 1402 is within a threshold distance of the target device 1404). During the ranging, the target device 1404 may dynamically switch the packet BW for the ranging based on aspects discussed above and in connection with FIGS. 14 to 16 (i.e., the dynamic BW selection), and the target device 1404 may also be configured to notify the target device 1404 when there is a BW change/switch.

Aspects presented herein may enable ranging devices or chipsets to perform ranging at further ranges than what they are currently capable of due to the adaptive BW selection methods described herein. Aspects presented herein may enable more accurate ranging due to the adaptive BW selection methods after reliable ranging is achieved. Aspects presented herein, through its adaptive BW selection that can result in better ranging accuracy, may also result in a more accurate direction finding when displacement-based algorithms are being used. For example, for Wi-Fi RTT based ranging, accuracy may be directly proportional to packet bandwidth but range capability is inversely proportional to packet bandwidth. Aspects presented herein provide techniques to dynamically select the bandwidth depending on the environment. In an embodiment, when target and ranging device are too far to do RTT ranging (detected by RSSI dropping), the two devices may negotiate to iteratively drop the packet BW until detection is achieved and ranging is possible. Now as the two devices come closer together, accuracy may become more important and ranging is possible with higher BW, so now the two devices may negotiate a higher BW.

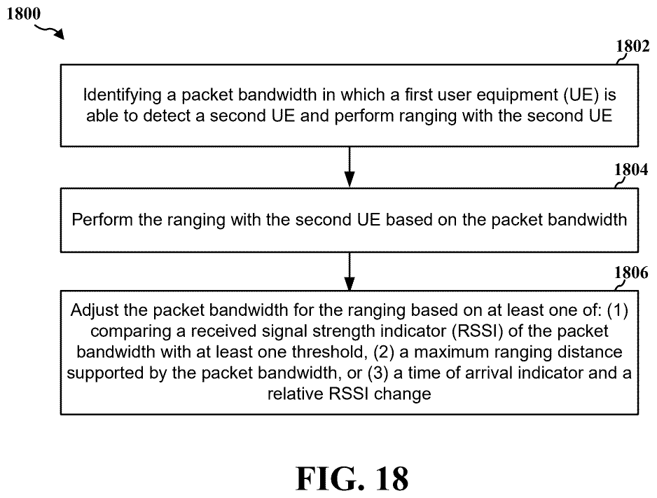

FIG. 18 is a flowchart 1800 of wireless communication at a user equipment (UE). The method may be performed by a first UE (e.g., the UE 104, 404; the first device 502; the second device 504; the ranging device 1402; the target device 1404; the apparatus 1904). The method may enable the first UE perform ranging with a second UE with a dynamic packet bandwidth selection to improve ranging capabilities for UEs at far distances or in scenarios with higher path loss/interference.

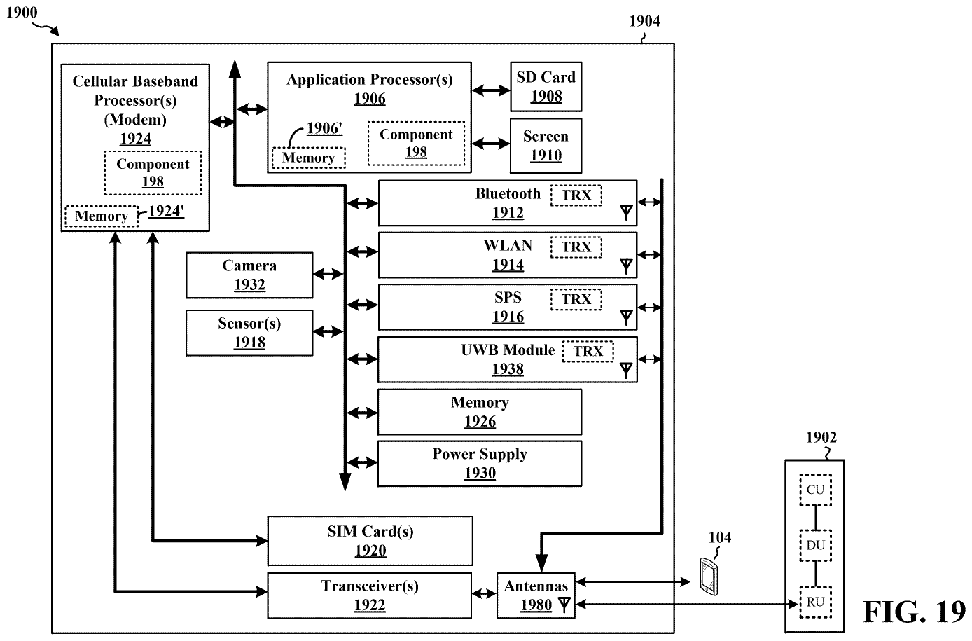

At 1802, the first UE may identify a packet bandwidth in which the first UE is able to detect a second UE and perform ranging with the second UE, such as described in connection with FIG. 14. For example, at 1416, if the ranging device 1402 is able to see/detect the target device 1404 when using a particular packet BW, the ranging device 1402 may next determine whether it is able to perform ranging with the target device 1404 based on using that particular packet BW. At 1418, if the ranging device 1402 is able to perform the ranging with the target device 1404 based on using a particular packet BW, the ranging device 1402 may be configured to use that particular packet BW for the ranging. The identification of the packet bandwidth may be performed by, e.g., the ranging component 198, the transceiver(s) 1922, the Bluetooth module 1912, the WLAN module 1914, the UWB module 1938, the cellular baseband processor(s) 1924, and/or the application processor(s) 1906 of the apparatus 1904 in FIG. 19.

At 1804, the first UE may perform the ranging with the second UE based on the packet bandwidth, such as described in connection with FIG. 14. For example, at 1418, if the ranging device 1402 is able to perform the ranging with the target device 1404 based on using a particular packet BW, the ranging device 1402 may be configured to use that particular packet BW for the ranging. The ranging may be performed by, e.g., the ranging component 198, the transceiver(s) 1922, the Bluetooth module 1912, the WLAN module 1914, the UWB module 1938, the cellular baseband processor(s) 1924, and/or the application processor(s) 1906 of the apparatus 1904 in FIG. 19.

At 1806, the first UE may adjust the packet bandwidth for the ranging based on at least one of: (1) comparing an RSSI of the packet bandwidth with at least one threshold, (2) a maximum ranging distance supported by the packet bandwidth, or (3) a time of arrival indicator and an RSSI change, such as described in connection with FIGS. 14 to 15. For example, during the ranging, the target device 1404 may dynamically switch the packet BW for the ranging (based on aspects discussed above—the dynamic packet BW selection), and the target device 1404 may also be configured to notify the target device 1404 when there is a packet BW change/switch. The adjustment of the packet bandwidth may be performed by, e.g., the ranging component 198, the transceiver(s) 1922, the Bluetooth module 1912, the WLAN module 1914, the UWB module 1938, the cellular baseband processor(s) 1924, and/or the application processor(s) 1906 of the apparatus 1904 in FIG. 19.

In one example, to identify the packet bandwidth in which the first UE is able to detect the second UE and perform ranging with the second UE, the first UE may be configured to determine that the first UE is unable to detect the second UE or perform the ranging with the second UE based on using a first packet bandwidth, reduce the first packet bandwidth to a second packet bandwidth until the first UE is able to detect the second UE and perform the ranging with the second UE using the second packet bandwidth, and identify the second packet bandwidth as the packet bandwidth in which the first UE is able to detect the second UE and perform ranging with the second UE.

In another example, to adjust the packet bandwidth for the ranging based on (1) comparing the RSSI of the packet bandwidth with the at least one threshold, the first UE may be configured to compare the RSSI of the packet bandwidth with the at least one threshold, and increase the packet bandwidth for the ranging if the RSSI of the packet bandwidth exceeds the at least one threshold.

In another example, to adjust the packet bandwidth for the ranging based on (1) comparing the RSSI of the packet bandwidth with the at least one threshold, the first UE may be configured to compare the RSSI of the packet bandwidth with the at least one threshold, and reduce the packet bandwidth for the ranging or refraining from increasing the packet bandwidth for the ranging if the RSSI of the packet bandwidth is below the at least one threshold.

In another example, to adjust the packet bandwidth for the ranging based on (2) the maximum ranging distance supported by the packet bandwidth, the first UE may be configured to identifying the maximum ranging distance supported by the packet bandwidth, compare an estimated distance between the first UE and the second UE with the maximum ranging distance supported by the packet bandwidth, and increase or decrease the packet bandwidth based on a difference between the estimated distance between the first UE and the second UE and the maximum ranging distance supported by the packet bandwidth.

In another example, to adjust the packet bandwidth for the ranging based on (2) the maximum ranging distance supported by the packet bandwidth, the first UE may be configured to identify at least a first distribution associated with a first maximum ranging distance supported by a first packet bandwidth and a second distribution associated with a second maximum ranging distance supported by a second packet bandwidth, identify a third distribution associated with an estimated distance between the first UE and the second UE, and select the first packet bandwidth or the second packet bandwidth as the packet bandwidth for the ranging based on an overlapping or an intersection between the first distribution and the third distribution or between the second distribution and the third distribution.

In another example, to adjust the packet bandwidth for the ranging based on (3) the time of arrival indicator and the RSSI change, the first UE may be configured to identify whether the time of arrival indicator is a positive value or a negative value, and reduce the packet bandwidth for the ranging if the time of arrival indicator is the negative value.

In another example, to adjust the packet bandwidth for the ranging based on (3) the time of arrival indicator and the RSSI change, the first UE may be configured to identify whether the time of arrival indicator is a positive value or a negative value, and maintain the packet bandwidth for the ranging if the time of arrival indicator is the positive value and a current RSSI is less than an RSSI threshold.

In another example, to adjust the packet bandwidth for the ranging based on (3) the time of arrival indicator and the RSSI change, the first UE may be configured to identify whether the time of arrival indicator is a positive value or a negative value, and increase the packet bandwidth for the ranging if the time of arrival indicator is the positive value and a current RSSI is more than or equal to an RSSI threshold.

In another example, the first UE may further transmit, to the second UE, an indication of the adjusted bandwidth.

In another example, the first UE may further estimate a position of the second UE based on the ranging, and output an indication of the estimated position of the second UE. In some implementations, to output the indication of the estimated position of the second UE, the first UE may be configured to transmit the indication of the estimated position of the second UE, display the indication of the estimated position of the second UE via a screen, or store the indication of the estimated position of the second UE. In some implementations, the first UE may further display, via a user interface (UI), the estimated position of the second UE. In some implementations, to display, via the UI, the estimated position of the second UE, the first UE may be configured to at least one of: display a direction of the second UE from the first UE, displaying a distance of the second UE from the first UE, or displaying an image or a description of the second UE.

In another example, the ranging corresponds to at least one of: Wi-Fi® ranging, ultrawide band (UWB) ranging, or Bluetooth® channel sounding (BTCS).

FIG. 19 is a diagram 1900 illustrating an example of a hardware implementation for an apparatus 1904. The apparatus 1904 may be a UE (e.g., a first UE), a component of a UE, or may implement UE functionality. In some aspects, the apparatus 1904 may include at least one cellular baseband processor 1924 (also referred to as a modem) coupled to one or more transceivers 1922 (e.g., cellular RF transceiver). The cellular baseband processor(s) 1924 may include at least one on-chip memory 1924′. In some aspects, the apparatus 1904 may further include one or more subscriber identity modules (SIM) cards 1920 and at least one application processor 1906 coupled to a secure digital (SD) card 1908 and a screen 1910. The application processor(s) 1906 may include on-chip memory 1906′. In some aspects, the apparatus 1904 may further include a Bluetooth module 1912, a WLAN module 1914, an ultrawide band (UWB) module 1938 (e.g., a UWB transceiver), an SPS module 1916 (e.g., GNSS module), one or more sensors 1918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the UWB module 1938, the WLAN module 1914, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize the antennas 1980 for communication. The cellular baseband processor(s) 1924 communicates through the transceiver(s) 1922 via one or more antennas 1980 with the UE 104 and/or with an RU associated with a network entity 1902. The cellular baseband processor(s) 1924 and the application processor(s) 1906 may each include a computer-readable medium/memory 1924′, 1906′, respectively. The additional memory modules 1926 may also be considered a computer-readable medium/memory. Each computer-readable medium/memory 1924′, 1906′, 1926 may be non-transitory. The cellular baseband processor(s) 1924 and the application processor(s) 1906 are each responsible for general processing, including the execution of software stored on the computer-readable medium/memory. The software, when executed by the cellular baseband processor(s) 1924/application processor(s) 1906, causes the cellular baseband processor(s) 1924/application processor(s) 1906 to perform the various functions described supra. The cellular baseband processor(s) 1924 and the application processor(s) 1906 are configured to perform the various functions described supra based at least in part of the information stored in the memory. That is, the cellular baseband processor(s) 1924 and the application processor(s) 1906 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1924/application processor(s) 1906 when executing software. The cellular baseband processor(s) 1924/application processor(s) 1906 may be a component of the UE 350 and may include the at least one memory 360 and/or at least one of the TX processor 368, the RX processor 356, and the controller/processor 359. In one configuration, the apparatus 1904 may be at least one processor chip (modem and/or application) and include just the cellular baseband processor(s) 1924 and/or the application processor(s) 1906, and in another configuration, the apparatus 1904 may be the entire UE (e.g., see UE 350 of FIG. 3) and include the additional modules of the apparatus 1904.

As discussed supra, the ranging component 198 may be configured to identify a packet bandwidth in which the first UE is able to detect a second UE and perform ranging with the second UE. The ranging component 198 may also be configured to perform the ranging with the second UE based on the packet bandwidth. The ranging component 198 may also be configured to adjust the packet bandwidth for the ranging based on at least one of: (1) comparing an RSSI of the packet bandwidth with at least one threshold, (2) a maximum ranging distance supported by the packet bandwidth, or (3) a time of arrival indicator and an RSSI change. The ranging component 198 may be within the cellular baseband processor(s) 1924, the application processor(s) 1906, or both the cellular baseband processor(s) 1924 and the application processor(s) 1906. The ranging component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1904 may include a variety of components configured for various functions. In one configuration, the apparatus 1904, and in particular the cellular baseband processor(s) 1924 and/or the application processor(s) 1906, may include means for identifying a packet bandwidth in which the first UE is able to detect a second UE and perform ranging with the second UE. The apparatus 1904 may further include means for performing the ranging with the second UE based on the packet bandwidth. The apparatus 1904 may further include means for adjusting the packet bandwidth for the ranging based on at least one of: (1) comparing an RSSI of the packet bandwidth with at least one threshold, (2) a maximum ranging distance supported by the packet bandwidth, or (3) a time of arrival indicator and an RSSI change.

In one configuration, the means for identifying the packet bandwidth in which the first UE is able to detect the second UE and perform ranging with the second UE may include configuring the apparatus 1904 to determine that the first UE is unable to detect the second UE or perform the ranging with the second UE based on using a first packet bandwidth, reduce the first packet bandwidth to a second packet bandwidth until the first UE is able to detect the second UE and perform the ranging with the second UE using the second packet bandwidth, and identify the second packet bandwidth as the packet bandwidth in which the first UE is able to detect the second UE and perform ranging with the second UE.

In another configuration, the means for adjusting the packet bandwidth for the ranging based on (1) comparing the RSSI of the packet bandwidth with the at least one threshold may include configuring the apparatus 1904 to compare the RSSI of the packet bandwidth with the at least one threshold, and increase the packet bandwidth for the ranging if the RSSI of the packet bandwidth exceeds the at least one threshold.

In another configuration, the means for adjusting the packet bandwidth for the ranging based on (1) comparing the RSSI of the packet bandwidth with the at least one threshold may include configuring the apparatus 1904 to compare the RSSI of the packet bandwidth with the at least one threshold, and reduce the packet bandwidth for the ranging or refraining from increasing the packet bandwidth for the ranging if the RSSI of the packet bandwidth is below the at least one threshold.

In another configuration, the means for adjusting the packet bandwidth for the ranging based on (2) the maximum ranging distance supported by the packet bandwidth may include configuring the apparatus 1904 to identifying the maximum ranging distance supported by the packet bandwidth, compare an estimated distance between the first UE and the second UE with the maximum ranging distance supported by the packet bandwidth, and increase or decrease the packet bandwidth based on a difference between the estimated distance between the first UE and the second UE and the maximum ranging distance supported by the packet bandwidth.

In another configuration, the means for adjusting the packet bandwidth for the ranging based on (2) the maximum ranging distance supported by the packet bandwidth may include configuring the apparatus 1904 to identify at least a first distribution associated with a first maximum ranging distance supported by a first packet bandwidth and a second distribution associated with a second maximum ranging distance supported by a second packet bandwidth, identify a third distribution associated with an estimated distance between the first UE and the second UE, and select the first packet bandwidth or the second packet bandwidth as the packet bandwidth for the ranging based on an overlapping or an intersection between the first distribution and the third distribution or between the second distribution and the third distribution.

In another configuration, the means for adjusting the packet bandwidth for the ranging based on (3) the time of arrival indicator and the RSSI change may include configuring the apparatus 1904 to identify whether the time of arrival indicator is a positive value or a negative value, and reduce the packet bandwidth for the ranging if the time of arrival indicator is the negative value.

In another configuration, the means for adjusting the packet bandwidth for the ranging based on (3) the time of arrival indicator and the RSSI change may include configuring the apparatus 1904 to identify whether the time of arrival indicator is a positive value or a negative value, and maintain the packet bandwidth for the ranging if the time of arrival indicator is the positive value and a current RSSI is less than an RSSI threshold.

In another configuration, the means for adjusting the packet bandwidth for the ranging based on (3) the time of arrival indicator and the RSSI change may include configuring the apparatus 1904 to identify whether the time of arrival indicator is a positive value or a negative value, and increase the packet bandwidth for the ranging if the time of arrival indicator is the positive value and a current RSSI is more than or equal to an RSSI threshold.

In another configuration, the apparatus 1904 may further include means for transmitting, to the second UE, an indication of the adjusted bandwidth.

In another configuration, the apparatus 1904 may further include means for estimating a position of the second UE based on the ranging, and means for outputting an indication of the estimated position of the second UE. In some implementations, the means for outputting the indication of the estimated position of the second UE may include configuring the apparatus 1904 to transmit the indication of the estimated position of the second UE, display the indication of the estimated position of the second UE via a screen, or store the indication of the estimated position of the second UE. In some implementations, the apparatus 1904 may further include means for displaying, via an UI, the estimated position of the second UE. In some implementations, the means for displaying, via the UI, the estimated position of the second UE may include configuring the apparatus 1904 to at least one of: display a direction of the second UE from the first UE, displaying a distance of the second UE from the first UE, or displaying an image or a description of the second UE.

In another configuration, the ranging corresponds to at least one of: Wi-Fi® ranging, UWB ranging, or BTCS.

The means may be the ranging component 198 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a first user equipment (UE), comprising: identifying a packet bandwidth in which the first UE is able to detect a second UE and perform ranging with the second UE; performing the ranging with the second UE based on the packet bandwidth; and adjusting the packet bandwidth for the ranging based on at least one of: (1) comparing a received signal strength indicator (RSSI) of the packet bandwidth with at least one threshold, (2) a maximum ranging distance supported by the packet bandwidth, or (3) a time of arrival indicator and a relative RSSI change.
Aspect 2 is the method of aspect 1, wherein identifying the packet bandwidth in which the first UE is able to detect the second UE and perform ranging with the second UE comprises: determining that the first UE is unable to detect the second UE or perform the ranging with the second UE based on using a first packet bandwidth; reducing the first packet bandwidth to a second packet bandwidth until the first UE is able to detect the second UE and perform the ranging with the second UE using the second packet bandwidth; and identifying the second packet bandwidth as the packet bandwidth in which the first UE is able to detect the second UE and perform ranging with the second UE.
Aspect 3 is the method of aspect 1 or aspect 2, wherein adjusting the packet bandwidth for the ranging based on (1) comparing the RSSI of the packet bandwidth with the at least one threshold comprises: comparing the RSSI of the packet bandwidth with the at least one threshold; and increasing the packet bandwidth for the ranging if the RSSI of the packet bandwidth exceeds the at least one threshold.
Aspect 4 is the method of any of aspects 1 to 3, wherein adjusting the packet bandwidth for the ranging based on (1) comparing the RSSI of the packet bandwidth with the at least one threshold comprises: comparing the RSSI of the packet bandwidth with the at least one threshold; and reducing the packet bandwidth for the ranging or refraining from increasing the packet bandwidth for the ranging if the RSSI of the packet bandwidth is below the at least one threshold.
Aspect 5 is the method of any of aspects 1 to 4, wherein adjusting the packet bandwidth for the ranging based on (2) the maximum ranging distance supported by the packet bandwidth comprises: identifying the maximum ranging distance supported by the packet bandwidth; comparing an estimated distance between the first UE and the second UE with the maximum ranging distance supported by the packet bandwidth; and increasing or decreasing the packet bandwidth based on a difference between the estimated distance between the first UE and the second UE and the maximum ranging distance supported by the packet bandwidth.
Aspect 6 is the method of any of aspects 1 to 5, wherein adjusting the packet bandwidth for the ranging based on (2) the maximum ranging distance supported by the packet bandwidth comprises: identifying at least a first distribution associated with a first maximum ranging distance supported by a first packet bandwidth and a second distribution associated with a second maximum ranging distance supported by a second packet bandwidth; identifying a third distribution associated with an estimated distance between the first UE and the second UE; and selecting the first packet bandwidth or the second packet bandwidth as the packet bandwidth for the ranging based on an overlapping or an intersection between the first distribution and the third distribution or between the second distribution and the third distribution.
Aspect 7 is the method of any of aspects 1 to 6, wherein adjusting the packet bandwidth for the ranging based on (3) the time of arrival indicator and the RSSI change comprises: identifying whether the time of arrival indicator is a positive value or a negative value; and reducing the packet bandwidth for the ranging if the time of arrival indicator is the negative value.
Aspect 8 is the method of any of aspects 1 to 7, wherein adjusting the packet bandwidth for the ranging based on (3) the time of arrival indicator and the RSSI change comprises: identifying whether the time of arrival indicator is a positive value or a negative value; and maintaining the packet bandwidth for the ranging if the time of arrival indicator is the positive value and a current RSSI is less than an RSSI threshold.
Aspect 9 is the method of any of aspects 1 to 8, wherein adjusting the packet bandwidth for the ranging based on (3) the time of arrival indicator and the RSSI change comprises: identifying whether the time of arrival indicator is a positive value or a negative value; and increasing the packet bandwidth for the ranging if the time of arrival indicator is the positive value and a current RSSI is more than or equal to an RSSI threshold.
Aspect 10 is the method of any of aspects 1 to 9, further comprising: transmitting, to the second UE, an indication of the adjusted packet bandwidth.
Aspect 11 is the method of any of aspects 1 to 10, further comprising: estimating a position of the second UE based on the ranging; and outputting an indication of the estimated position of the second UE.
Aspect 12 is the method of any of aspects 1 to 11, wherein outputting the indication of the estimated position of the second UE comprises: transmitting the indication of the estimated position of the second UE, displaying the indication of the estimated position of the second UE via a screen, or storing the indication of the estimated position of the second UE.
Aspect 13 is the method of any of aspects 1 to 12, further comprising: displaying, via a user interface (UI), the estimated position of the second UE.
Aspect 14 is the method of any of aspects 1 to 13, wherein displaying, via the UI, the estimated position of the second UE includes at least one of: displaying a direction of the second UE from the first UE, displaying a distance of the second UE from the first UE, or displaying an image or a description of the second UE.
Aspect 15 is the method of any of aspects 1 to 14, wherein the ranging corresponds to at least one of: Wi-Fi® ranging, ultrawide band (UWB) ranging, or Bluetooth® channel sounding (BTCS).
Aspect 16 is an apparatus for wireless communication at a first user equipment (UE), including: at least one memory; and at least one processor coupled to the at least one memory and, based at least in part on stored information that is stored in the at least one memory, the at least one processor, individually or in any combination, is configured to implement any of aspects 1 to 15.
Aspect 17 is the apparatus of aspect 16, further including at least one transceiver coupled to the at least one processor.
Aspect 18 is an apparatus for wireless communication at a first user equipment (UE) including means for implementing any of aspects 1 to 15.
Aspect 19 is a computer-readable medium (e.g., a non-transitory computer-readable medium) storing computer executable code, where the code when executed by a processor causes the processor to implement any of aspects 1 to 15.

What is claimed is:

1. An apparatus for wireless communication at a first user equipment (UE), comprising:
at least one memory; and
at least one processor coupled to the at least one memory, wherein the at least one processor is configured to:
identify a packet bandwidth in which the first UE is able to detect a second UE and perform ranging with the second UE;
perform the ranging with the second UE based on the packet bandwidth; and
adjust the packet bandwidth for the ranging based on at least one of: (1) comparing a received signal strength indicator (RSSI) of the packet bandwidth with at least one threshold, (2) a maximum ranging distance supported by the packet bandwidth, or (3) a time of arrival indicator and a relative RSSI change.

2. The apparatus of claim 1, wherein to identify the packet bandwidth in which the first UE is able to detect the second UE and perform the ranging with the second UE, the at least one processor is configured to:
determine that the first UE is unable to detect the second UE or perform the ranging with the second UE based on using a first packet bandwidth;
reduce the first packet bandwidth to a second packet bandwidth until the first UE is able to detect the second UE and perform the ranging with the second UE using the second packet bandwidth; and
identify the second packet bandwidth as the packet bandwidth in which the first UE is able to detect the second UE and perform ranging with the second UE.

3. The apparatus of claim 1, wherein to adjust the packet bandwidth for the ranging based on (1) comparing the RSSI of the packet bandwidth with the at least one threshold, the at least one processor is configured to:
compare the RSSI of the packet bandwidth with the at least one threshold; and
increase the packet bandwidth for the ranging if the RSSI of the packet bandwidth exceeds the at least one threshold.

4. The apparatus of claim 1, wherein to adjust the packet bandwidth for the ranging based on (1) comparing the RSSI of the packet bandwidth with the at least one threshold, the at least one processor is configured to:
compare the RSSI of the packet bandwidth with the at least one threshold; and
reduce the packet bandwidth for the ranging or refraining from increasing the packet bandwidth for the ranging if the RSSI of the packet bandwidth is below the at least one threshold.

5. The apparatus of claim 1, wherein to adjust the packet bandwidth for the ranging based on (2) the maximum ranging distance supported by the packet bandwidth, the at least one processor is configured to:
identify the maximum ranging distance supported by the packet bandwidth;
compare an estimated distance between the first UE and the second UE with the maximum ranging distance supported by the packet bandwidth; and
increase or decrease the packet bandwidth based on a difference between the estimated distance between the first UE and the second UE and the maximum ranging distance supported by the packet bandwidth.

6. The apparatus of claim 1, wherein to adjust the packet bandwidth for the ranging based on (2) the maximum ranging distance supported by the packet bandwidth, the at least one processor is configured to:
identify at least a first distribution associated with a first maximum ranging distance supported by a first packet bandwidth and a second distribution associated with a second maximum ranging distance supported by a second packet bandwidth;
identify a third distribution associated with an estimated distance between the first UE and the second UE; and
select the first packet bandwidth or the second packet bandwidth as the packet bandwidth for the ranging based on an overlapping or an intersection between the first distribution and the third distribution or between the second distribution and the third distribution.

7. The apparatus of claim 1, wherein to adjust the packet bandwidth for the ranging based on (3) the time of arrival indicator and the RSSI change, the at least one processor is configured to:
identify whether the time of arrival indicator is a positive value or a negative value; and
reduce the packet bandwidth for the ranging if the time of arrival indicator is the negative value.

8. The apparatus of claim 1, wherein to adjust the packet bandwidth for the ranging based on (3) the time of arrival indicator and the RSSI change, the at least one processor is configured to:
identify whether the time of arrival indicator is a positive value or a negative value; and
maintain the packet bandwidth for the ranging if the time of arrival indicator is the positive value and a current RSSI is less than an RSSI threshold.

9. The apparatus of claim 1, wherein to adjust the packet bandwidth for the ranging based on (3) the time of arrival indicator and the RSSI change, the at least one processor is configured to:
identify whether the time of arrival indicator is a positive value or a negative value; and
increase the packet bandwidth for the ranging if the time of arrival indicator is the positive value and a current RSSI is more than or equal to an RSSI threshold.

10. The apparatus of claim 1, wherein the at least one processor is further configured to:
transmit, to the second UE, an indication of the adjusted bandwidth.

11. The apparatus of claim 1, wherein the at least one processor is further configured to:
estimate a position of the second UE based on the ranging; and
output an indication of the estimated position of the second UE.

12. The apparatus of claim 11, wherein to output the indication of the estimated position of the second UE, the at least one processor is configured to:
transmit the indication of the estimated position of the second UE,
display the indication of the estimated position of the second UE via a screen, or
store the indication of the estimated position of the second UE.

13. A method of wireless communication at a first user equipment (UE), comprising:
identifying a packet bandwidth in which the first UE is able to detect a second UE and perform ranging with the second UE;
performing the ranging with the second UE based on the packet bandwidth; and
adjusting the packet bandwidth for the ranging based on at least one of: (1) comparing a received signal strength indicator (RSSI) of the packet bandwidth with at least one threshold, (2) a maximum ranging distance supported by the packet bandwidth, or (3) a time of arrival indicator and a relative RSSI change.

14. The method of claim 13, wherein identifying the packet bandwidth in which the first UE is able to detect the second UE and perform the ranging with the second UE comprises:
determining that the first UE is unable to detect the second UE or perform the ranging with the second UE based on using a first packet bandwidth;
reducing the first packet bandwidth to a second packet bandwidth until the first UE is able to detect the second UE and perform the ranging with the second UE using the second packet bandwidth; and
identifying the second packet bandwidth as the packet bandwidth in which the first UE is able to detect the second UE and perform the ranging with the second UE.

15. The method of claim 13, wherein adjusting the packet bandwidth for the ranging based on (1) comparing the RSSI of the packet bandwidth with the at least one threshold comprises:
comparing the RSSI of the packet bandwidth with the at least one threshold; and
increasing the packet bandwidth for the ranging if the RSSI of the packet bandwidth exceeds the at least one threshold.

16. The method of claim 13, wherein adjusting the packet bandwidth for the ranging based on (1) comparing the RSSI of the packet bandwidth with the at least one threshold comprises:
comparing the RSSI of the packet bandwidth with the at least one threshold; and
reducing the packet bandwidth for the ranging or refraining from increasing the packet bandwidth for the ranging if the RSSI of the packet bandwidth is below the at least one threshold.

17. The method of claim 13, wherein adjusting the packet bandwidth for the ranging based on (2) the maximum ranging distance supported by the packet bandwidth comprises:
identifying the maximum ranging distance supported by the packet bandwidth;
comparing an estimated distance between the first UE and the second UE with the maximum ranging distance supported by the packet bandwidth; and
increasing or decreasing the packet bandwidth based on a difference between the estimated distance between the first UE and the second UE and the maximum ranging distance supported by the packet bandwidth.

18. The method of claim 13, wherein adjusting the packet bandwidth for the ranging based on (2) the maximum ranging distance supported by the packet bandwidth comprises:
identifying at least a first distribution associated with a first maximum ranging distance supported by a first packet bandwidth and a second distribution associated with a second maximum ranging distance supported by a second packet bandwidth;
identifying a third distribution associated with an estimated distance between the first UE and the second UE; and
selecting the first packet bandwidth or the second packet bandwidth as the packet bandwidth for the ranging based on an overlapping or an intersection between the first distribution and the third distribution or between the second distribution and the third distribution.

19. The method of claim 13, wherein adjusting the packet bandwidth for the ranging based on (3) the time of arrival indicator and the RSSI change comprises:
identifying whether the time of arrival indicator is a positive value or a negative value; and
reducing the packet bandwidth for the ranging if the time of arrival indicator is the negative value, maintaining the packet bandwidth for the ranging if the time of arrival indicator is the positive value and a current RSSI is less than an RSSI threshold, or increasing the packet bandwidth for the ranging if the time of arrival indicator is the positive value and the current RSSI is more than or equal to the RSSI threshold.

20. A computer-readable medium storing computer executable code at a first user equipment (UE), the code when executed by at least one processor causes the at least one processor to:
identify a packet bandwidth in which the first UE is able to detect a second UE and perform ranging with the second UE;
perform the ranging with the second UE based on the packet bandwidth; and
adjust the packet bandwidth for the ranging based on at least one of: (1) comparing a received signal strength indicator (RSSI) of the packet bandwidth with at least one threshold, (2) a maximum ranging distance supported by the packet bandwidth, or (3) a time of arrival indicator and a RSSI change.
